(19) United States
(12) Patent Application Publication
(10) Pub. No.: US 2022/0287894 A1
(43) Pub. Date: Sep. 15, 2022

(54) SUPPORT MECHANISM AND MOBILE APPARATUS USING SAME

(71) Applicant: University of Tsukuba, Ibaraki (JP)

(72) Inventors: Kenji SUZUKI, Ibaraki (JP); Diego PAEZ GRANADOS, Ibaraki (JP); Hideki KADONE, Ibaraki (JP); Yosuke EGUCHI, Ibaraki (JP); Kai SASAKI, Ibaraki (JP)

(21) Appl. No.: 17/637,677

(22) PCT Filed: Aug. 28, 2020
(86) PCT No.: PCT/JP2020/032762

§ 371 Date: Feb. 23, 2022

(30) Foreign Application Priority Data
Aug. 30, 2019 (JP) 2019-159109
Aug. 30, 2019 (JP) 2019-159110
Sep. 30, 2019 (JP) 2019-178827

(51) Int. Cl. A61G 5/14

(52) U.S. Cl. CPC A61G 5/14; A61G 2200/34; A61G 2200/36; A61G 2200/58; A61G 2203/34

(57) ABSTRACT

It is possible to quickly and efficiently support a user with a limited lower limb motor function in a posture transition with a simplified configuration. A support mechanism that supports a posture transition includes a first link that does not change a posture, a second link that is rotatably coupled to the first link, and an actuator configured to rotate the second link with respect to the first link, in which, when a load on a connection part of the second link and the first link changes due to a change in an upper body posture of a user, based on a relative positional relationship between an ankle joint and a knee joint of the user in a direction orthogonal to a vertical direction in a sagittal plane of the user, the actuator drives the second link while changing a support moment on the user according to a relative positional relationship between the knee joint and an upper body centroid of the user, or a knee joint angle.

### TECHNICAL FIELD

The present invention relates to a support mechanism for supporting a posture transition between a sitting position and a standing position, and a mobile apparatus using the support mechanism.

### BACKGROUND ART

A posture-variable standing mobile apparatus provided with a mechanism to support movement of a user transitioning from a sitting position to a standing position or from a standing position to a sitting position according to the movement of the weight of the upper body of the user is known (for example, see PTL 1). This apparatus supports movements of the ankle and knee joints by using a first pivoting member corresponding to the movements of the ankle joint, a second pivoting member corresponding to the movements of the knee joint, and individual actuators independently driving the first and second pivoting members.

Elimination is an occasion that requires a user to transform postures. An elimination supporting wheelchair with a seat surface constituted by a plurality of sequentially connected seat plates and an opening formed on the seat surface for elimination has been proposed (for example, see PTL 2).

### CITATION LIST

### Patent Literature

PTL 1: Japanese Patent No. 6377888
PTL 2: JP 2009-172108 A

### SUMMARY OF INVENTION

### Technical Problem

The mechanism of PTL 1 has mechanisms that individually drive a plurality of joints to support the lower limbs with a complex configuration. In addition, it is difficult to quickly and efficiently support standing movements or seating movements of users with an impaired lower limb motor function. In addition, it is difficult for such users to lower down and raise up their clothes without a caregiver because their body parts around their hips are fixed. The wheelchair of PTL 2 does not include a support mechanism to transform a posture, and thus assistance of a caregiver is needed for a series of actions of helping a user stand up from the wheelchair, opening the seat surface of the wheelchair, and causing the user to be seated at the position corresponding to the toilet seat for elimination.

The present invention aims to provide a support mechanism for quickly and efficiently supporting a user with a limited lower limb motor function in a posture transition with a simplified configuration and a mobile apparatus using the support mechanism. In addition, for one aspect of posture transforming, a support mechanism that supports elimination is provided.

### Solution to Problem

To achieve the above-described objective, according to an aspect of the present invention, a support mechanism includes a first link that does not change a posture, a second link that is rotatably connected to the first link, and an actuator configured to rotate the second link with respect to the first link, in which, when a load on a connection part of the second link and the first link changes due to a change in an upper body posture of a user based on a relative positional relationship between an ankle joint and a knee joint of the user in a direction orthogonal to a vertical direction in a sagittal plane of the user, the actuator drives the second link while changing a support moment on the user according to a relative positional relationship between the knee joint and an upper body centroid, or a knee joint angle.

### Advantageous Effects of Invention

The simplified configuration enables a user with a limited lower limb motor function to be quickly and efficiently supported in a posture transition.

### BRIEF DESCRIPTION OF DRAWINGS

FIG. 1 is a diagram illustrating comparison of the operation principle of a support mechanism of the embodiment on a flat surface with that of a conventional structure.

FIG. 2 is a diagram illustrating comparison of the operation principle of the support mechanism of the embodiment on a slope surface with that of the conventional structure.

FIG. 3 is an external view of a support mechanism according to a first embodiment and a mobile apparatus using the support mechanism.

FIG. 4 is a diagram illustrating use modes of the mobile apparatus in a sitting posture and a standing posture.

FIG. 5 is a side view of the mobile apparatus in a sitting position.

FIG. 6 is a side view of the mobile apparatus in a standing position.

FIG. 7 is a diagram for describing a sitting posture and a standing posture of a user.

FIG. 8 is a diagram for describing the types and directions of moments acting around the knee joint.

FIG. 9 is a diagram of a human body model for estimating a load on a user.

FIG. 10 is a graph of the posture transition model assumed at the time of design.

FIG. 11 is a graph showing examples of a load moment estimated value acting around a knee joint and a design target value of a support moment based on the estimated value.

FIG. 12 is a diagram for describing generation of a support moment by an actuator.

FIG. 13 is a diagram for describing review on disposition of an actuator.

FIG. 14 is a graph showing an example of characteristics of a support moment in accordance with a knee joint angle.

FIG. 15 is a diagram illustrating a comparison example for generating a support moment by an actuator.

FIG. 16 is a graph showing comparison of characteristics of the support moment in the configuration of FIG. 15 with characteristics of the support moment in the configuration of FIG. 12.

FIG. 17 is a diagram illustrating an example of a mechanism for adjusting a magnitude of a support moment according to physical characteristics of a user.

FIG. 18 is a schematic diagram of a mobile apparatus using a support mechanism according to a second embodiment, illustrating a state of the support mechanism in a sitting posture.

FIG. 19 is a schematic diagram of the mobile apparatus using the support mechanism for a posture transition according to the second embodiment, illustrating a state of the support mechanism in a standing posture.

FIG. 20 is a diagram illustrating a state of movement in a standing posture.

FIG. 21 is a diagram for describing coordinate systems of q2 and q3.

FIG. 22 is a diagram of a human body model in the second embodiment.

FIG. 23 is a diagram illustrating a cycle of a posture transition of a user.

FIG. 24 is a diagram illustrating a change in a joint angle in accordance with the posture transition of FIG. 23.

FIG. 25 is a diagram illustrating a change in a joint load moment in accordance with the posture transition of FIG. 23.

FIG. 26 is a model of power generation by an actuator of the support mechanism according to the second embodiment.

FIG. 27 is a graph showing knee joint moments when a posture changing motion is made.

FIG. 28 is a diagram for describing the moments acting around the knee joint q2.

FIG. 29 is a diagram illustrating a configuration example of a force transmission system.

FIG. 30 is a side view of a mobile apparatus using the force transmission system of FIG. 29 in a sitting position.

FIG. 31 is a side view of the mobile apparatus using the force transmission system of FIG. 29 in a standing position.

FIG. 32 is a diagram illustrating another configuration example of the force transmission system.

FIG. 33A is a diagram illustrating a configuration example of a transmission rod of the force transmission system of FIG. 32.

FIG. 33B is a diagram illustrating another configuration example of the transmission rod of the force transmission system of FIG. 32.

FIG. 34 is a diagram illustrating a sensor arrangement example of a third link.

FIG. 35 is a diagram for describing movement control of a standing-type mobile apparatus.

FIG. 36 is a diagram for describing a basic concept of a support mechanism according to a third embodiment.

FIG. 37 is a diagram for describing the basic concept of the support mechanism according to the third embodiment.

FIG. 38 is a diagram for describing the basic concept of the support mechanism according to the third embodiment.

FIG. 39 is a perspective view of the support mechanism according to the third embodiment, illustrating a state in a standing position.

FIG. 40 is a perspective view of the support mechanism according to the third embodiment, illustrating a state in a sitting position.

FIG. 41 is a front view of the support mechanism in a standing position state.

FIG. 42 is a side view of the support mechanism in the standing position state.

FIG. 43 is a diagram illustrating a state of use of the support mechanism in a standing position.

FIG. 44 is a diagram illustrating a state of use of the support mechanism in a sitting position.

FIG. 45 is a schematic diagram of a posture transforming model applied to the support mechanism according to the third embodiment.

FIG. 46 is a diagram for describing the principle of a passive actuator for rotating a frame structure around a knee joint.

FIG. 47 is a perspective view of a support mechanism according to a modified example of the third embodiment.

FIG. 48 is a side view of the support mechanism according to the modified example of the third embodiment.

FIG. 49 is a rear view of the support mechanism according to the modified example of the third embodiment.

### DESCRIPTION OF EMBODIMENTS

In embodiments, a passive mechanism using a single actuator generates a support force for posture transforming corresponding to a movement of a knee joint of a user, unlike in known configurations. More specifically, a support moment is generated and changed according to a relative positional relationship between the centroid of the upper body and a knee joint of a user during posture transforming. Here, the “upper body” refers to a portion above the waist of a human body and includes a torso, an upper limb, a neck, and the head. Characteristics of a support moment reflect the relative positional relationship between knee and ankle joints of a user in a direction orthogonal to the vertical direction in the sagittal plane.

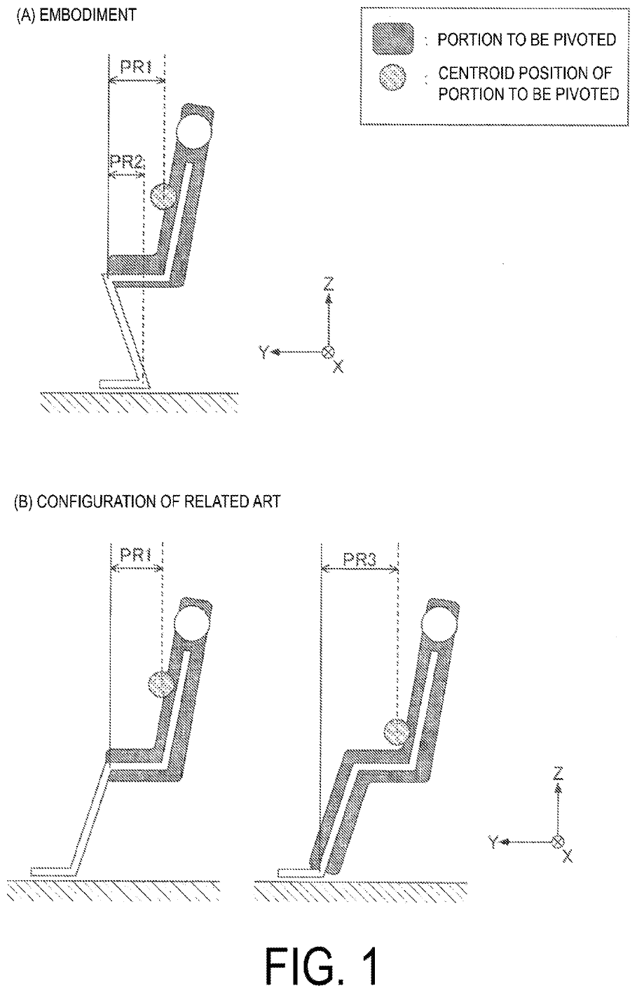

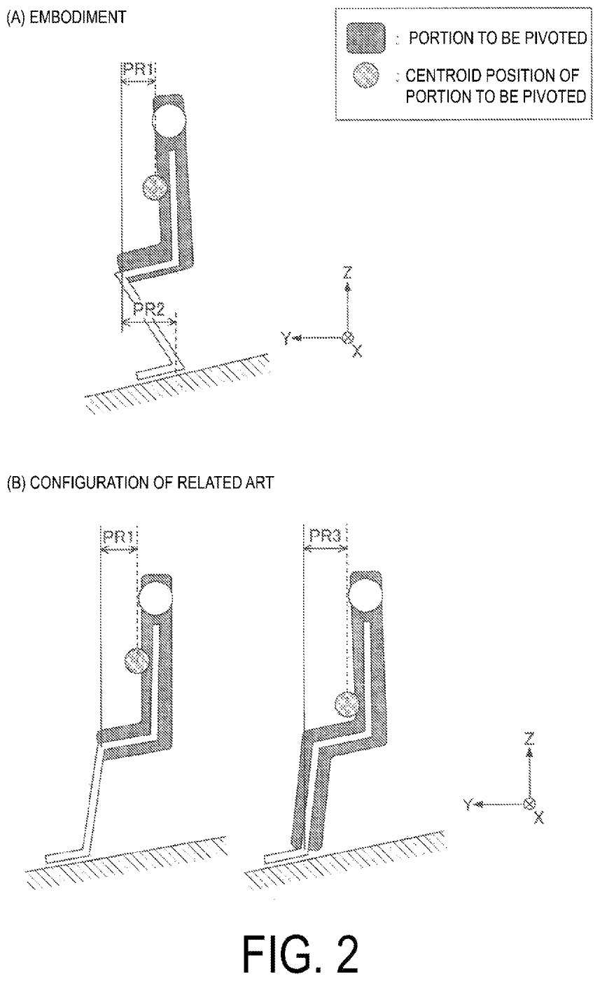

FIG. 1 is a diagram illustrating comparison of the operation principle of a support mechanism of the embodiment on a flat surface with that of a conventional structure. FIG. 2 is a diagram illustrating comparison of the operation principle of the support mechanism of the embodiment on a slope surface with that of the conventional structure. It is assumed in FIGS. 1 and 2 that the direction in which a user advances is a Y direction, the height direction is a Z direction, and the direction orthogonal to the Y and Z directions is an X direction. The sagittal plane corresponds to the Y-Z plane. The support mechanism of the embodiment is based on the knowledge that, when a user transitions his or her position from a sitting position to a standing position or from a standing position to a sitting position, an ankle joint of the user is fixed at a predetermined position in the negative Y direction from the knee joint and thus the user can stably transform postures.

In FIG. 1, when a user positioned on a flat surface stands up, for example, from a sitting position, rotations of the ankle and knee joints of the user, that is, a relative positional relationship PR2 between the ankle and knee joints and a relative positional relationship RP1 between the knee joint and the centroid of the upper body determines a required rotational force of the ankle and knee joints to be exerted. At this moment, the relative positional relationship PR2 between the ankle and knee joints in the Y direction within the Y-Z plane affects energy required to extend the ankle joint. The ankle joint being positioned in the negative Y direction from the knee joint helps the energy allocated for a movement of the ankle joint to be reduced and thus it is easier to exert the rotational force of the knee joint to transition to a standing position. Also when the user transitions his or her position from the standing position to a sitting position, the user positions his or her ankle joint in the negative Y direction from the knee joint which stabilizes and facilitates the seating motion. By determining PR2 as a means to adequately extend both the ankle and knee joints using a single actuator, the force of the actuator can be suitably distributed to the ankle and knee joints.

In contrast, in the conventional structure, a relative positional relationship PR1 between a knee joint and the centroid of the upper body of a user and a relative positional relationship PR3 between the ankle joint and the centroid of the upper body are independently considered, and thus separate actuators implement support for the knee joint according to its rotation and support for the ankle joint according to its rotation.

In following embodiments, specific configurations of mechanisms that support a user's posture transitions will be provided based on the above-described operation principles. In the accompanying drawings, the same constituent components may be labeled with the same reference signs and overlapping descriptions thereof may be omitted.

### First Embodiment

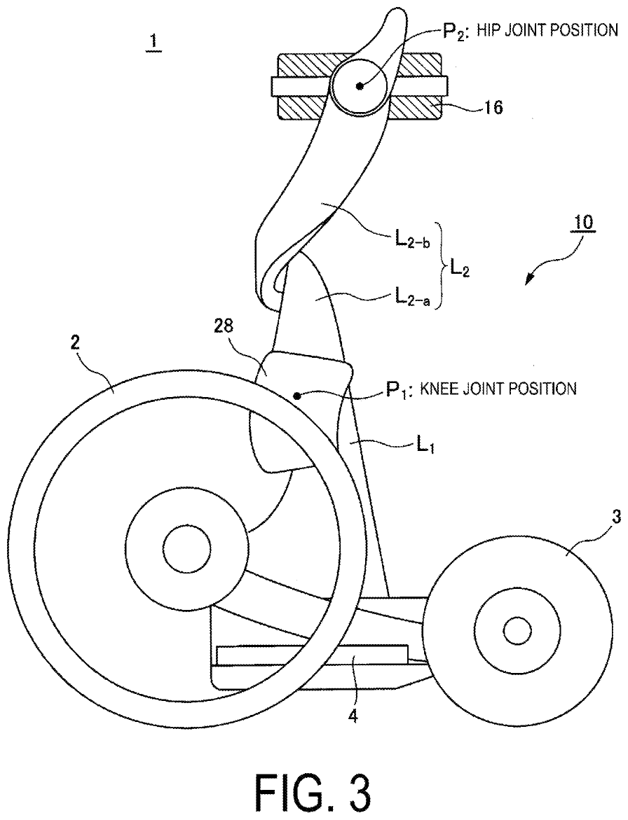

A first embodiment of the present invention will be described with reference to FIGS. 3 to 17. In the first embodiment, for example, a support mechanism that supports a posture transition from a sitting position to a standing position or from a standing position to a sitting position realizes a support motion corresponding to a movement of a user's knee joint with a single actuator. This support mechanism is a passive mechanism, and thus it does not require supply of power to support posture transitions. An appropriate support force is generated according to a change in posture transitioning of a user between sitting and standing positions.

Apparatus Appearance and Overview

FIG. 3 is a schematic view illustrating the appearance of a mobile apparatus 1 having a support mechanism 10 for posture transitions. The support mechanism 10 has a first link L₁ and a second link L₂ that is pivotably coupled to the first link L₁. The second link L₂ has a link body L₂₋ₐ and a support link L_{2-b} connected to the link body L₂₋ₐ. The support link L_{2-b} moves integrally with the link body L₂₋ₐ to support the thighs of a user. The second link L₂ is driven by an actuator to be described later, and rotates around a connection part with respect to the first link L₁ to support the posture transition of the user. The second link L₂ has a mechanically limited range of motion of about 80 degrees.

The connection part between the first link L₁ and the second link L₂ corresponds to the user's knee joint position P₁. The end of the support link L_{2-b} of the second link L₂ corresponds to the user's hip joint position P₂.

The first link L₁ is fixed to the mobile apparatus 1 or a floor suspension, or the like to support the feet and lower limbs of the user. The first link L₁ may be provided with a knee joint support member 28 that holds a position of the user's knees. In addition, a support band 16 that supports the hip of the user may be connected to the second link L₂. Although not illustrated, a strap that supports the thighs, a seat-like structure that covers from the hip to the thighs, or the like may be connected to the second link L₂ if needed.

The mobile apparatus 1 having the support mechanism 10 has a pair of front wheels 2 and a pair of rear wheels 3. The front wheels 2 are, for example, main wheels, and drive the mobile apparatus 1. The rear wheels 3 are trailing wheels and are mounted to be turnable. By configuring the rear wheels 3 as small diameter wheels, the mobile apparatus 1 can be brought into proximity to an object on which the user wants to be seated, such as a chair or a bench. A footrest 4 is disposed between the front wheels 2 and the rear wheels 3. The first link L₁ can be fixed to the footrest 4, a frame connecting the front wheels 2 to the rear wheels 3, a base of the mobile apparatus 1, or the like.

Further, it is not necessary to set the front wheels 2 as main wheels and the rear wheels 3 as trailing wheels, and the front wheels 2 may be trailing wheels and the rear wheels 3 may be drive wheels. In this case, the front wheels 2 may be caster-type trailing wheels.

Although the support mechanism 10 is incorporated into the mobile apparatus 1 in the example of FIG. 3, it is not limited to application to the mobile apparatus 1, and can be combined with a motor drive system. It is also possible to mount a floor suspension, etc. to the support mechanism 10 to support a posture transition of a user. For example, a support mechanism 10 can be disposed in a rehabilitation chamber, a user's room, or the like, to be used to support his or her daily life such as rehabilitation, exercise, transfer, bathing, and the like.

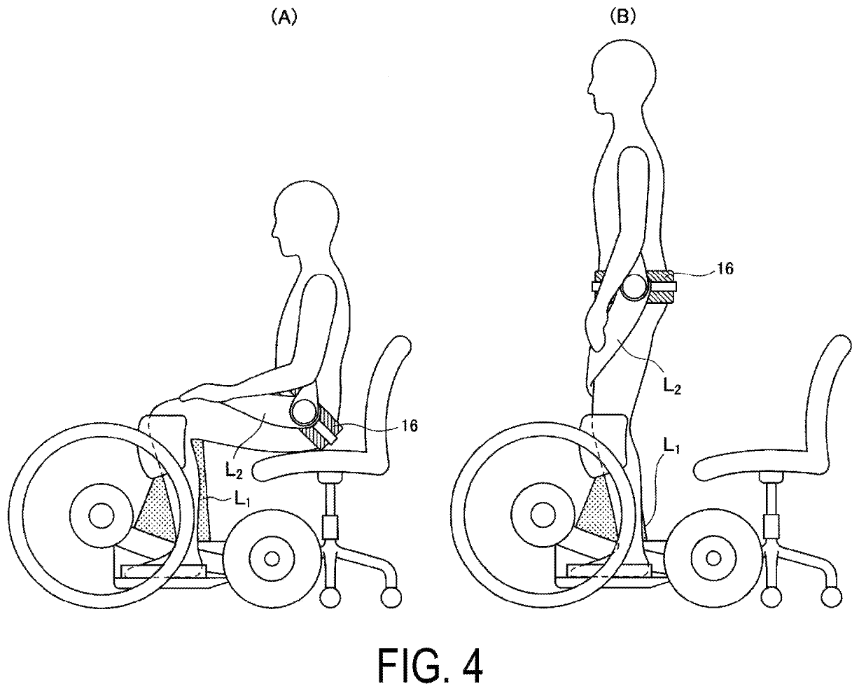

FIG. 4 is a diagram illustrating a mode of use in which the support mechanism 10 and the mobile apparatus 1 are combined in a sitting position and a standing position. In FIG. 4(A), for example, a user is sitting on a desired seat of a chair, a bench, or the like. The user is seated having the first link L₁ fixed to the mobile apparatus 1 between his feet. The rear wheels 3 can be placed under the seat of the chair, and thus the user can sit thereon to a desired depth. The second link L₂ that supports the thighs of the user is laid at an angle substantially horizontal to the floor.

In FIG. 4(B), when the user stands up, the knee joint of the user extends to about 80 degrees with respect to the floor. The user stands up having the first link L₁ between his or her feet. At this moment, the second link L₂ supporting the thighs of the user rises up at an angle close to 80 degrees from the floor surface. The support link L_{2-b} (see FIG. 3) of the second link L₂ corresponding to the thighs of the user is, for example, a Y-shaped link. The two branches of the Y-shape extend towards both thighs of the user. A shape of the support link L_{2-b} of the second link L₂ is not limited to a Y-shaped structure disposed at the front of the user and may be a U shape, an arch shape, or the like, may not necessarily branch as long as it can support the user's thighs, or may be disposed on the rear side of the user in a seat shape.

Although the support mechanism 10 is a passive mechanism and there is no need to supply a driving force, the mobile apparatus 1 may be provided with a drive mechanism that drives the front wheels 2 and a controller for movement control. For example, in-wheel motors that drive the front wheels 2 as motors built into the front wheels 2 may be provided.

A rotation direction of the front wheels 2 changes according to the posture of the upper body of the standing user, and thus the user can move in a desired direction in the standing position. Furthermore, a difference in rotation speed of the pair of the left and right front wheels 2 enables turning, rotation on the spot, and the like.

Description of Mechanism

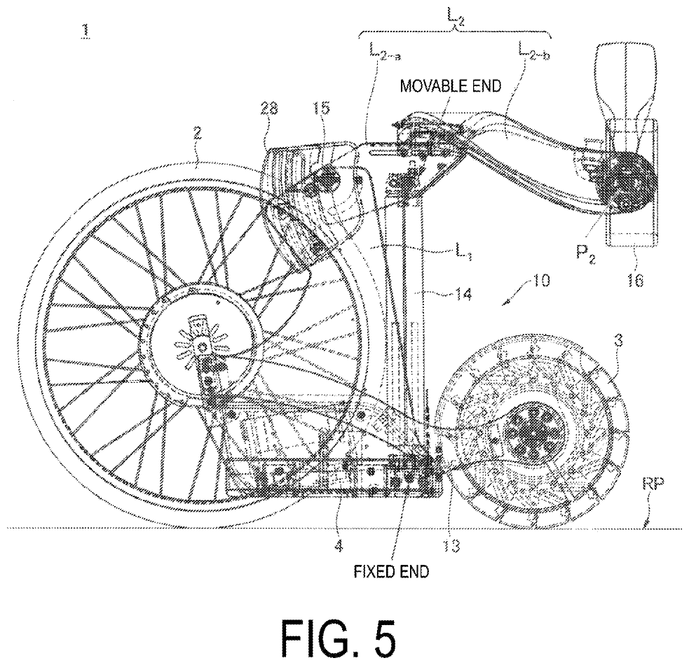

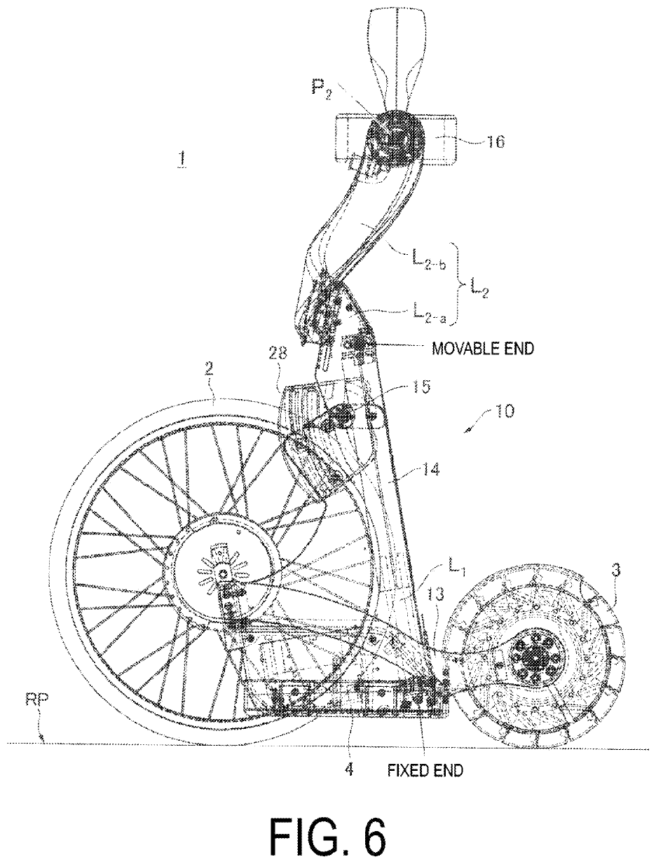

FIGS. 5 and 6 are diagrams for describing the structure of the mobile apparatus 1 from a side, representing states in a sitting position and a standing position. The mobile apparatus 1 moves the user to a desired location while supporting the user's posture with the support mechanism 10.

The second link L₂ provided to the support mechanism 10 is coupled to the first link L₁ by a rotation node 15. While the second link L₂ transitions between a seating position and a standing position using an actuator 14, the first link L₁ is fixed. A fixed end of the actuator 14 is fixed at a suitable part on the first link L₁ and the other end is fixed to the link body L₂₋ₐ of the second link L₂. The second link L₂ changes its posture according to rotation of the rotation node 15. The position of the other end of the actuator 14 changes due to a change in a posture of the second link L₂. In this sense, the other end of the actuator 14 may be referred to as a “movable end”.

The actuator 14 is installed at a position at which an operation of the support mechanism 10 for supporting posture transforming can be effectively induced according to a load applied to the rotation node 15 connecting the first link L₁ and the second link L₂ due to a change in posture of the upper body of the user. The movable end of the actuator 14 pivots the second link L₂ to be fixed at an appropriate position at which it can support the posture transition of the user. The fixed end of the actuator 14 may be set on the first link L₁ or may be fixed to a base 13 or another part.

Although a set of three gas springs is used for the actuator 14 in the examples of FIGS. 5 and 6, appropriate elastic members such as viscoelastic dampers using liquid pressure, coil springs, rubber springs, and the like can be used. In addition, as the actuator 14, wind-up springs, torsion coil springs, and the like may be used in the vicinity of the rotation node 15. Even when a set of gas springs is used, they are a single actuator in the sense that they drive the second link L₂ with respect to the first link L₁. This significantly differs from the known art in which a first portion corresponding to an ankle joint and a second portion corresponding to a knee joint are driven by a plurality of actuators, respectively.

In the state in the sitting position of FIG. 5, the second link L₂ is held at an angle that is close to being parallel to a reference plane RP. The rotation node 15 of the support mechanism 10 pivots the second link L₂ such that the first link L₁ and the second link L₂ are on a straight line or in a posture close to a straight line to support the standing movement of the user. As a result, the second link L₂ is lifted to an angle that is close to being perpendicular to the reference plane RP and transitions to the upright state of FIG. 6. A support band 16 for the hip may be mounted at the position corresponding to the hip joint position P₂ of the user.

Although, in the state of FIG. 5, the actuator 14 is compressed to have a biasing force in a direction substantially perpendicular to the reference plane RP, the actuator 14 can be locked at a certain length. When the actuator is unlocked to help the user stand up, the biasing force of the actuator 14 is released and the second link L₂ is pushed up to support the user in the direction in which the user stands up. In the state in the standing position of FIG. 6, the biasing force of the actuator 14 is minimized, and the load applied to the connection part between the first link L₁ and the second link L₂ from the user is minimized as well. If the actuator 14 is locked in this state, it is possible to maintain the standing posture regardless of the position of the upper body of the user.

When the user is to be seated from the state of FIG. 6, the actuator 14 is unlocked and the user tilts his or her upper body backward to be seated, and thus a load applied to the connection part between the first link L₁ and the second link L₂ increases. The system is designed such that the biasing force of the actuator 14 is slightly less than the load from the user to be seated in the entire seating process, and thus the movement of the user to be seated can be stably supported. The relationship between the supporting force from the actuator 14 and the load from the user will be described in more detail below.

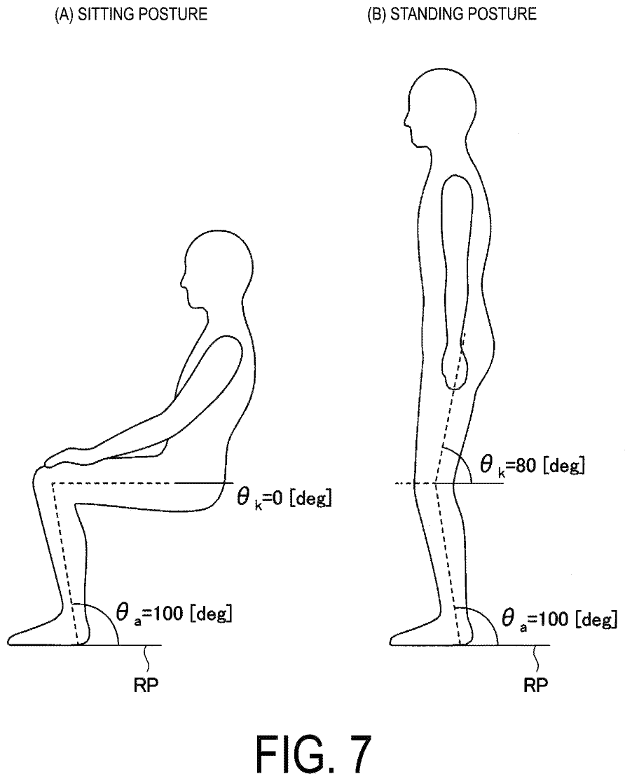

FIG. 7 is a diagram for describing a sitting posture and a standing posture of a user. Although there is little change in the angle of the ankle joint of the user in the sitting and standing postures in the example of FIG. 7, the corresponding first link L₁ may pivot with respect to the base 13 to provide some degree of a rotation margin around the ankle joint. The angle formed by the line segment connecting the ankle and knee joints of the user and the reference plane RP (an ankle joint angle θₐ) is constant at approximately 100 degrees. On the other hand, the angle formed by the line segment connecting the knee and hip joints of the user and the reference plane RP (a knee joint angle θₖ) changes from about 0 degrees to about 80 degrees. Here, each angle does not have to be an exact angle, and rather implies an approximate angle, and for example, a case in which a knee joint extends to have nearly 90 degrees is also included. The support mechanism 10 of the embodiment efficiently supports movements of the knee joints of the user based on the ankle joint angle θₐ or the relative positional relationship PR2 (see FIG. 1) between the ankle and knee joints.

In the seating position of FIG. 5, the line segment connecting the rotation node 15 corresponding to the knee joint and the hip joint position P₂ is parallel to the reference plane RP. The rotation node 15 rotates as the user moves to stand up, and the second link L₂ moves in the direction to extend. The knee joint angle θₖ (see FIG. 7) formed by the line segment connecting the rotation node 15 and the hip joint position P₂ and the reference plane RP increases in the range from 0 degrees to 80 degrees. Here, the “extension” refers to a posture change in which the first link L₁ and the second link L₂ are on a straight line or in a posture close to a straight line.

As the rotation node 15 rotates when the user moves to be seated, the second link L₂ is bent until it is substantially parallel to the reference plane RP, i.e., the second link L₂ is moved until Ok is 0 degrees. Here, the “bending” refers to a posture change in the direction opposite to the “extension”. The actuator 14 can take any configuration in which the second link L₂ can be “extended” and “bent” according to a load moment applied from the user to the rotation node 15.

Description of Principle

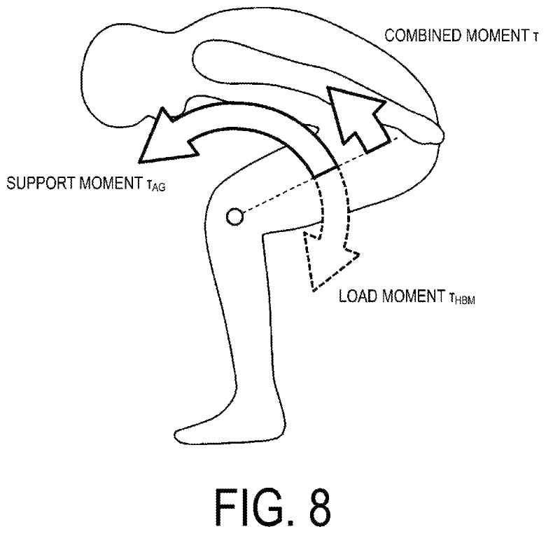

FIG. 8 is a diagram for describing the relationship between a load moment coming from a user acting on the knee joint of the user and a support moment. The load moment τ_{HBM} acting in the seating direction and the support moment τ_{AG} acting in the standing direction act around the knee joint at the same time. The load moment τ_{HBM} is generated due to gravity and a posture of the user. The support moment τ_{AG} is generated by an action of the actuator 14. Consequently, a combined moment τ of the load moment τ_{HBM} and the support moment τ_{AG} acts around the knee joint. When the user performs a standing movement or a seating movement, the direction and magnitude of the combined moment τ change according to the change in the load moment τ_{HBM} from the user, and the rotation node 15 rotates to support the user with the movement. The support mechanism 10 operates in accordance with such a change in balance and does not require a power supply or control device. In the design stage, characteristics, disposition, etc. of the actuator 14 are calculated so that the load moment τ_{HBM} applied when a user transforms his or her posture is predicted and an appropriate support moment τ_{AG} is generated based on the predicted moment.

Estimate of Load Moment τ_{HBM}

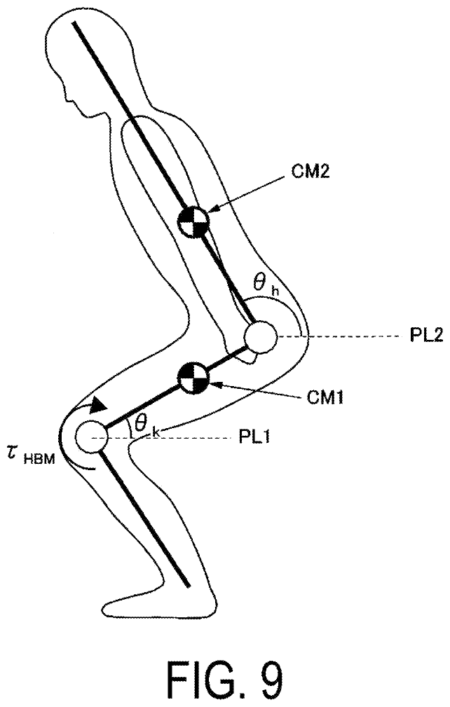

FIG. 9 is a diagram of a human body model for estimating a load moment τ_{HBM} applied by a user. The human body model was made by taking a knee joint angle θₖ with reference to a plane PL1 parallel to the reference plane RP and likewise a hip joint angle θₕ with reference to PL2 and with links corresponding to a lower limb, a thigh, and the upper body using the knee joint and the hip joint as nodes. Here, the hip joint angle θₕ is an angle formed by a line segment connecting the hip joint and the acromion of the user and the reference plane RP or the plane PL2. The positions of the centroids of the thigh and the upper body are indicated on the corresponding links, and the load moment τ_{HBM} that is generated around the knee joint due to the relationship between gravity and the positions of the centroids is indicated.

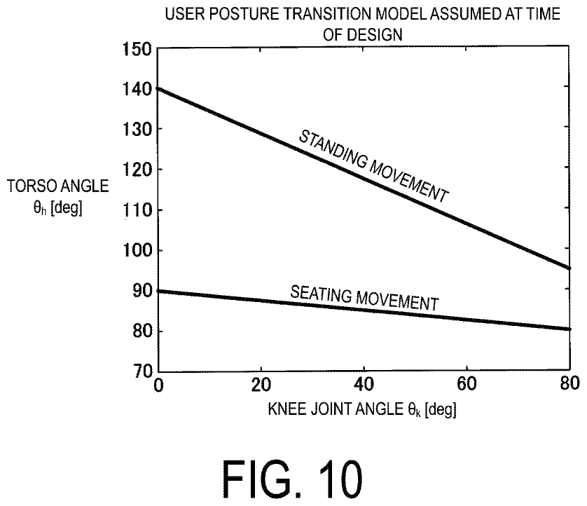

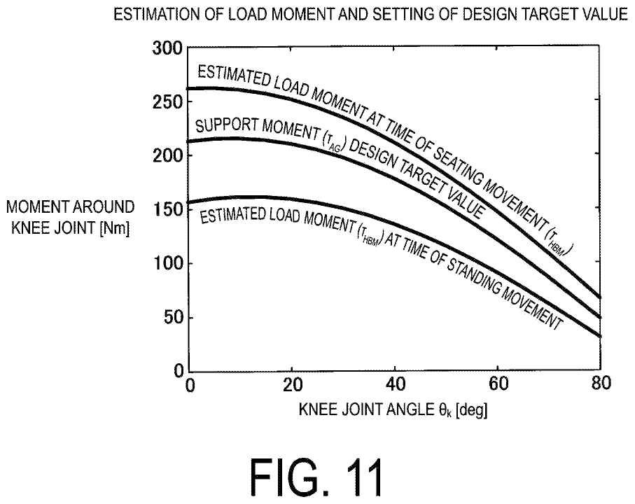

FIG. 10 shows a use posture transition model assumed at the time of design. FIG. 11 is a graph showing examples of types of a posture transition, an estimated value of the load moment τ_{HBM} acting around the knee joint, and a design target value of a support moment based on the estimated value of the load moment. The graph of FIG. 10 shows transitions of the knee joint angle θₖ and the hip joint angle θₕ as defined in FIG. 9 during a standing movement and a seating movement. The results of the load moment τ_{HBM} using the human body model of FIG. 9 based on the transition characteristics are shown in the graph of FIG. 11. An estimated value of the load moment may vary depending on design requirements such as an application target and a mass of the apparatus. While FIG. 11 is one design example based on the model of FIG. 9, the relationship between the load moment τ_{HBM} and the support moment τ_{AG} and the trend of the change are as shown in FIG. 11. Although a characteristic target value of the support moment τ_{AG} may be set to the average value of the load moments at the time of the standing movement and the seating movement in the design of the example, any characteristic target value of the support moment may be set as long as it is possible to support a posture transition in accordance with the balance of the moments illustrated in FIG. 8.

Design of τ_{AG} Generation Mechanism

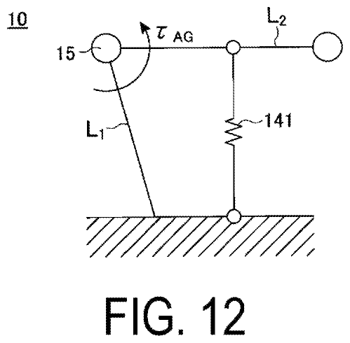

FIG. 12 is a diagram for describing generation of a support moment by the actuator 14. In FIG. 12, an elastic body 141 is used as an actuator. The support mechanism 10 is schematically formed by a first link L₁ by which a posture is fixed with respect to the reference plane RP, a second link L₂ that is rotatably coupled to the first link L₁ by a rotation node 15, and the elastic body 141 that drives the second link L₂.

The elastic body 141 transfers a repulsive force to the first link L₁ and the second link L₂, and generates a support moment τ_{AG} in a direction in which the second link L₂ extends around the rotation node 15.

A magnitude of the support moment τ_{AG} is determined in accordance with a posture of the second link L₂ with respect to the first link L₁.

In the transition starting phase in which a user attempts to stand up from a seated state, the user load moment τ_{HBM} has a maximum value on the knee joint. The reason for this is that, in FIG. 9, the load moment τ_{HBM} around the knee joint is determined by the horizontal distance of the centroid (CM1) of the thigh and the centroid (CM2) of the upper body with respect to the knee joint, and thus the distance to the position of the centroid at the seating position is greatest.

Because the elastic body 141 has been designed to be installed at a position according to the specifications selected to generate the support moment τ_{AG} that is balanced with this load, the ideal support moment τ_{AG} has the largest magnitude when the user starts the standing movement from the seated state. As the user stands up and the entire body extends vertically, i.e., as the horizontal distance between the centroid (CM1) of the thigh and the centroid of the upper body (CM2) with respect to the knee joint decreases, the load moment τ_{HBM} around the knee joint is reduced, the support moment τ_{AG} is designed to be generated to be balanced with the load, and therefore the support moment τ_{AG} decreases.

When the user attempts to change a position from the standing position to the seated position, the load moment τ_{HBM} acting on the knee joint increases as flexion of the knee for seating becomes greater. Because the elastic body 141 causes the support moment τ_{AG} that is balanced with this load to be generated, the ideal support moment τ_{AG} has the largest magnitude immediately before seating.

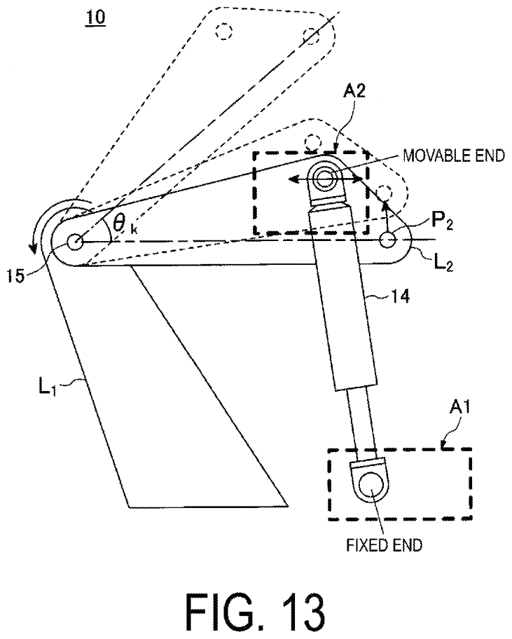

FIG. 13 is a diagram for describing review on disposition of the actuator 14. The position of the fixed end of the actuator 14 is appropriately designed within the range of a disposition-possible region A1 of the fixed end in order to satisfy constraints depending on an external environment, such as a chair on which the user is seated, and a disposition relationship with other components within the apparatus. Similarly, the movable end of the actuator 14 is fixed within the range of a disposition-possible region A2 of the movable end on the second link L₂. Characteristics such as the fixed positions of the fixed end and the movable end of the actuator 14 in the disposition-possible regions A1 and A2 and a spring constant of the actuator 14 are combined and studied to obtain characteristics close to the support moment characteristic target value set in FIG. 11.

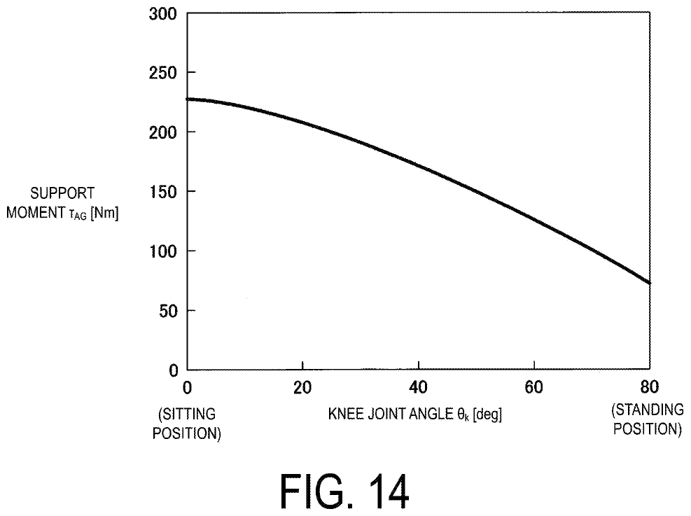

FIG. 14 is a graph showing an example of characteristics of a support moment in accordance with knee joint angles obtained as results of the design review in the example. The horizontal axis represents the knee joint angle θₖ (degrees) and the vertical axis represents support moment τ_{AG} generated by the elastic body 141 around the rotation node 15. A position with the knee joint angle θₖ of 0 degrees corresponds to a sitting position, and a position with the knee joint angle θₖ of 80 degrees corresponds to a standing position. The greater the knee joint angle θₖ, the lower the support moment τ_{AG}.

Characteristics such as the positions and spring constants of the fixed end and the movable end of the elastic body 141 are determined such that the difference (e.g., the sum of squares of the error with respect to the target value) at each knee joint angle θₖ between the target support moment obtained from the discussion in FIGS. 10 and 11 and the support moment τ_{AG} to be generated is minimized. Although the characteristics of the support moment of FIG. 14 do not completely match those of the support moment (τ_{AG}) design target values of FIG. 11, they are complemented by finely tuning the torso angle when the user performs a standing or seating movement.

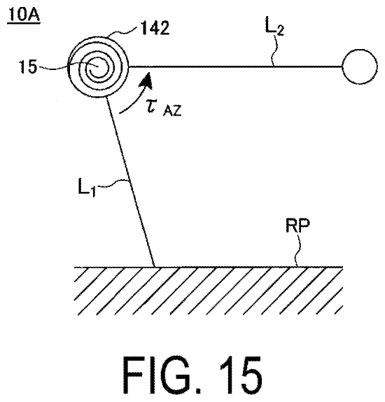

FIG. 15 illustrates a reference example for generation of a support moment by the actuator 14. In the reference example, a wind-up spring 142 is used as the actuator. A support mechanism 10A is schematically formed by a first link L₁ by which a posture is fixed with respect to the reference plane RP, a second link L₂ that is rotatably coupled to the first link L₁ by a rotation node 15, and the wind-up spring 142 provided in the rotation node 15.

The wind-up spring 142 is included in the rotation node 15 and generates a support moment τ_{AZ} to support the knee joint according to a knee joint angle θₖ.

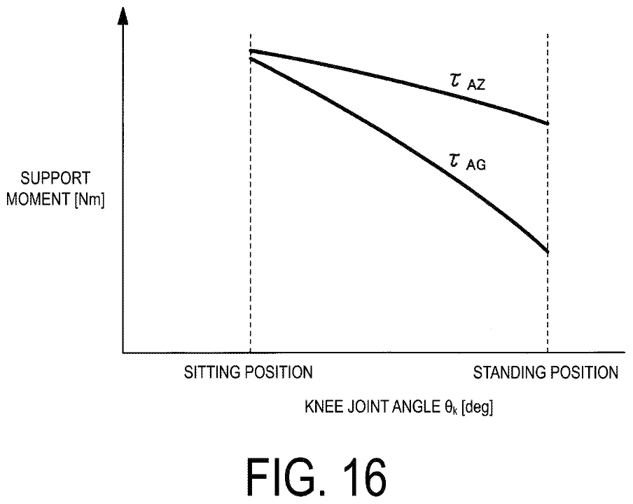

FIG. 16 illustrates the characteristics of the support moment τ_{AZ} in the configuration of FIG. 15, along with the characteristics of the support moment τ_{AG} in the configuration of FIG. 12. With a wind-up spring built into the rotation node 15 is used, a rate of change of the support moment τ_{AZ} becomes smaller as compared to the support moment τ_{AG}, but it is still possible to generate a support moment following the change in the load moment τ_{HBM} generated around the knee joint of the user transitioning his or her posture. In the configuration of FIG. 12, the elastic body 141 is mounted such that an error with an ideal support moment is minimized based on the load moment τ_{HBM} generated around the knee joint of the user, and thus a support moment τ_{AG} can be generated according to the load moment τ_{HBM} applied to the knee joint.

Also with the configuration of FIG. 15, by designing the spring force of the wind-up spring 142 such that a large support moment is obtained in the sitting position, like τ_{AG} in FIG. 16 and a small support moment is obtained in the standing position, the support moment τ_{AZ} can be generated to follow a change in the load moment of the user. Here, the graph in FIG. 16 represents the trend of the support moment with respect to the knee joint angle θₖ and does not represent a ratio of an actual magnitude.

Thus, the user can move the upper body with his or her own intent to control the equilibrium between the load moment τ_{HBM} acting on the knee joint and the support moment τ_{AG} (or τ_{AZ}) by the support mechanism 10 to perform a standing movement and a seating movement. This property can also be utilized by the user to optionally stop and resume a movement in any posture when performing a posture transforming movement.

Even a user who is not able to voluntarily control the lower limbs can autonomously move the upper body to change a posture between sitting and standing positions. Since transforming of a posture based on movement of the upper body of the user is supported, this is also suitable for supporting standing and seating movements in rehabilitation training of users with a limited lower limb motor function due to spinal cord injuries, strokes, cerebral paralysis, and the like.

Although the characteristics of the support moment of FIG. 14 are optimized for supporting users with a height of 180 cm and a body weight of 72 kg in the design example, characteristics of the moment generated by the actuator 14 can be optimized depending on a height, a body weight, a state of lower limbs of the user, etc. By providing such a support moment adjustment mechanism described below, a support moment suitable for a user with physical conditions, such as, for example, a height from 145 cm to 180 cm and a body weight from 40 kg to 100 kg can be generated.

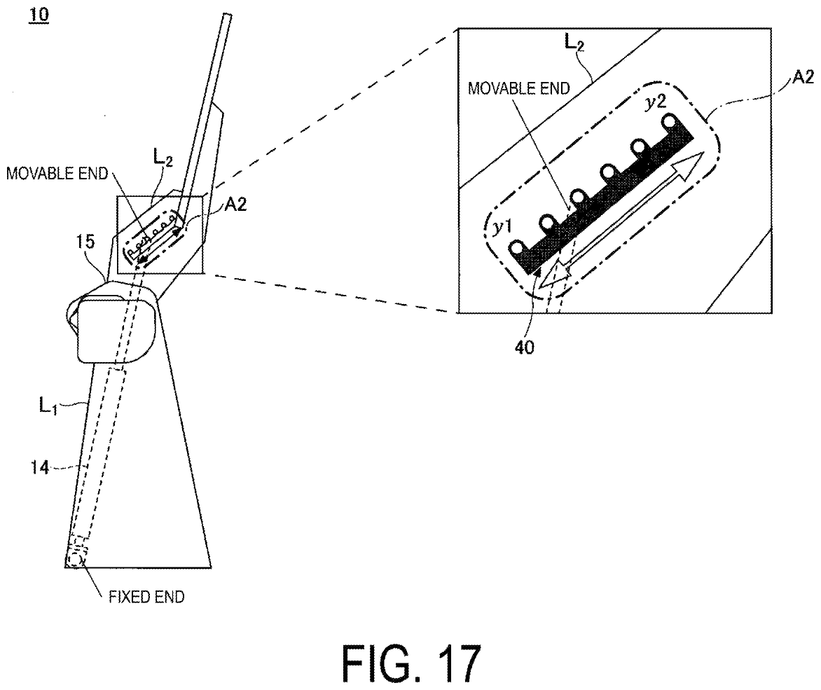

FIG. 17 is a diagram illustrating a configuration example of a support moment adjustment mechanism 40 operating according to physical characteristics of a user. The support moment adjustment mechanism 40 makes the mounting position of the movable end of the actuator 14 that rotates the second link L₂ with respect to the first link L₁ variable within the disposition-possible region A2. This provides optimal support moments to users with different heights and body weights.

The fixed end of the actuator 14 is fixed to the first link L₁ in the disposition-possible region A1 (see FIG. 13). The mounting position of the movable end of the actuator 14 is changeable in the range from y1 to y2. For example, a plurality of mounting parts may be provided between y1 and y2 so that the position is switchable in multiple stages, or the movable end may be locked at a desired position by continuously changing the mounting position of the movable end. For a user with a small body, the position of the movable end of the actuator 14 is set at the mounting point y1 or a nearby point. For a user with a large body, the position of the movable end of the actuator 14 is set at the mounting point y2 or a nearby point. When the mounting point y2 is selected, a moment arm from the knee joint (rotation axis) is longer compared to when the mounting point y1 is selected, and thus a larger support moment can be generated.

As an example, it may be assumed that the smallest physical characteristics of an assumed user include a height of 145 cm and a body weight of 40 kg, and the largest include a height of 190 cm and a body weight of 100 kg. First, a fixed end mounting point on the first link L₁, a movable end mounting point y2 on the second link L₂, and specifications of the actuator 14 are determined for the largest physical characteristics. Next, a mounting point y1 on the second link L₂ for the smallest physical characteristics is determined based on the position and specifications of the fixed end mounting point of the actuator 14. A plurality of mounting points are provided on the line segment (which may be a straight or curved line) connecting y1 and y2 to allow the mounting position of the movable end of the actuator 14 to be changed. This allows a posture transition of the user to be supported even though the physical characteristics of the user using the support mechanism 10 varies.

As described above, the single actuator 14 of the support mechanism 10 of the embodiment generates a support moment τ_{AG} greater than the load moment τ_{HBM} from the user applied to the support mechanism 10 in the entire range of standing movements and changes the support moment τ_{AG} according to extension of the knee joint.

The actuator 14 generates a support moment τ_{AG} smaller than the load moment τ_{HBM} from the user applied to the support mechanism 10 in the entire range of seating movements and changes the support moment τ_{AG} according to bending of the knee joint.

If the mobile apparatus 1 is used in combination with the support mechanism 10, an upright movement support apparatus can be provided as an alternative to existing wheelchairs that are used in a sitting posture.

With regard to the support mechanism of the embodiment, the time taken from when a user starts stretching his or her knees that have been bent in a sitting position to when the user reaches a standing state is about 2.5 seconds, and thus the standing time can be shortened to about ¼ to ⅕ of the time taken in the configuration of the related art in which the individual actuators are each used to support rotations of the ankle and knee joints. In a seating movement, the time from when a user starts bending his or her knees to be seated to when the user reaches a seated state is about 2.3 seconds, and thus it can be shortened to about ¼ of the time taken in the configuration of the related art. This can support quick and efficient posture transitions.

### DESCRIPTION OF USE EXAMPLES

1. Attaching/Detaching of Apparatus

The support band 16 is removed from the main body of the support mechanism 10 and is placed on a seat surface on which a user is to be seated, such as a chair or a bed. The user wears the support band 16 in a manner that the user sits thereon. The support mechanism 10 in a sitting posture is brought close to the user from the front of his or her legs such that his or her feet are fitted on the footrest 4. When the support mechanism 10 is brought closer to the user, the knee joints of the user are fitted in the knee joint support member 28 and at the same time, the support band 16 reaches the connection position to the second link L₂ of the support mechanism 10. An operation to connect the support band 16 to the second link L₂ is performed to complete the wearing operation. When the apparatus is to be removed, the wearing operation is performed in the reverse order in the sitting posture.

2. Standing/Seating Movement

When a posture is to be changed, the actuator 14 is unlocked to make the knee joints movable. A standing movement is started when a user tilts his or her upper body forward, a seating movement is started when the user tilts his or her upper body backward, and a posture transition movement can be optionally stopped or reversed by adjusting the posture of his or her upper body. After a desired posture is taken and a movement of the knee joint is stopped, the actuator 14 is locked to make the knee joints fixed. This operation allows the user to safely attach and detach the apparatus or to freely have an upper body posture while maintaining a standing or sitting posture.

### Second Embodiment

In a second embodiment, in addition to the first link L₁ and the second link L₂, a third link L₃ is used to stabilize the torso of a user during a posture transition, and a movement of the knee joints and a movement of the torso can be linked.

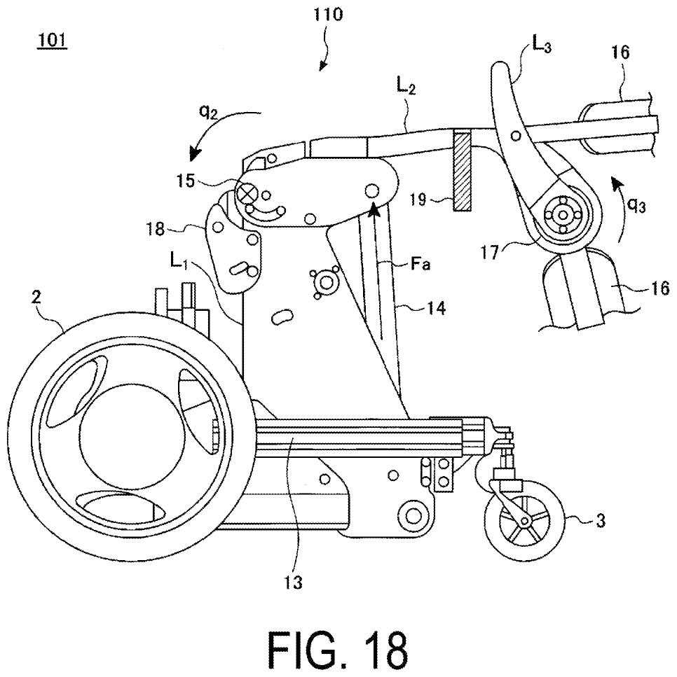

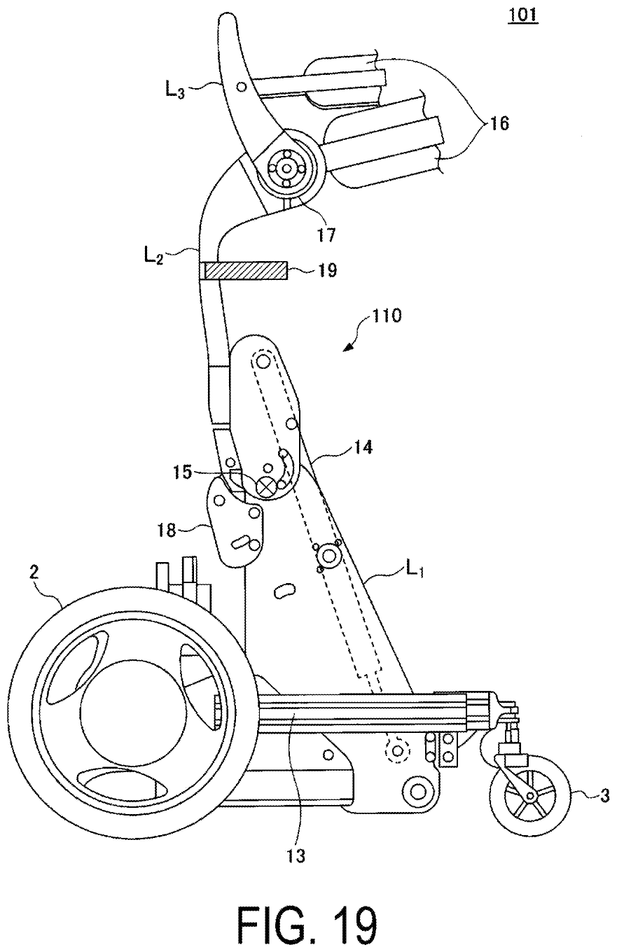

FIGS. 18 and 19 are side views of a mobile apparatus 101 having a support mechanism 110 for posture transitions. FIG. 18 illustrates a state of the support mechanism 110 in a sitting position, and FIG. 19 illustrates a state of the support mechanism 110 in a standing position.

The support mechanism 110 includes a first link L₁ that is fixed to a base 13 of the mobile apparatus 101, a second link L₂ that is pivotably coupled to the first link L₁, and an actuator 14 that pivots the second link L₂ with respect to the first link L₁. The first link L₁ and the second link L₂ are connected by a rotation node 15.

The support mechanism 110 also includes a third link L₃ that is coupled to the second link L₂ and a rotation node 17 that rotatably connects the third link, L₃ to the second link L₂. By providing a force transmission system between the third link L₃ and the second link L₂ as will be described below, the single actuator 14 can be used to synchronize a movement of a knee joint q2 with a movement of a waist joint q3 to support the user with a posture transition.

The actuator 14 causes the support mechanism 110 to move to support posture transforming when a load applied to the rotation node 15 connecting the first link L₁ and the second link L₂ changes due to the user changing his or her upper body posture. A force acting on the second link L₂ by the actuator 14 is defined as Fa.

The third link L₃ carries the upper body of the user, and during a posture transition, a force transmitted from the upper body of the user to the second link L₂ via the third link L₃ is linearized by the force transmission system described below. Here, “linearizing” the transmitted force refers to monotonically increasing or decreasing the force from the waist joint q3 on the knee joint q2 with respect to the angle of the knee joint q2. Linearizing the force coming from a motion of the waist joint q3 allows the user to smoothly perform standing and seating movements. The support mechanism 110 is a passive support mechanism that does not require supply of power.

Although a set of gas springs is used for the actuator 14 in the examples of FIGS. 18 and 19, appropriate elastic members such as viscoelastic dampers using liquid pressure, coil springs, rubber springs, and the like can be selected. Even when a set of gas springs is used, they are a single actuator in the sense that they drive the second link L₂ with respect to the first link L₁. This significantly differs from the known art in which a first portion corresponding to an ankle joint and a second portion corresponding to a knee joint are driven by individual actuators.

The first link L₁ is fixed to the base 13 to support the feet and the lower limb of the user. The first link L₁ may be provided with a part 18 that holds a position of the knees of the user. In actual use, a knee support serving as an interface with the user can be disposed on an outer side of the part 18. The second link L₂ corresponds to the thighs of the user and is connected to the first link L₁ by the rotation node 15. The second link L₂ has a mechanically limited movement range of about 90 degrees. The third link L₃ is coupled to the second link L₂ at the rotation node 17 corresponding to the waist joint q3 of the user to support the torso of the user around his or her abdomen. The support band 16 supporting the hip of the user may be connected to the rotation node 17. Additionally, a strap 19 to support the thighs may be connected to the second link L₂.

In the seated state of FIG. 18, the second link L₂ is held to the base 13 or the movement surface at an angle close to the horizontal line. The third link L₃ is positioned diagonally upward from the second link L₂ to support the torso of the user around his or her abdomen attempting to stand from the sitting position. When the user changes his or her posture from the sitting position to a standing position, the knee joint q2 moves in the direction of the arrow q2 and the waist joint q3 moves in the direction opposite to the arrow q3. The rotation node 15 corresponding to the knee joint q2 rotates in the direction of the arrow q2 to support the user with the standing movement. This support operation is based on the balance or the resultant force of the moment acting in the standing direction by the actuator 14 and the moment acting in the seating direction by the posture of the upper body of the user.

When the rotation node 15 is rotated in the direction of the arrow q2, the rotation node 17 connecting the second link L₂ and the third link L₃ changes in the direction opposite to the arrow q3, thus the third link L₃ is pushed upward toward the top of the paper, and the upper body of the user trying to stand up is stably supported. Details of this operation will be described below.

In the standing position of FIG. 19, the second link L₂ is raised from the base 13 or the movement surface to an angle that is close to the vertical line. The third link L₃ is located approximately parallel to the direction in which the second link L₂ is raised in order to support the raised torso of the user.

A pair of front wheels 2 and a pair of rear wheels 3 are provided in the mobile apparatus 101 including the support mechanism 110. The front wheels 2 are main wheels, and drive the mobile apparatus 101. A rotation direction of the front wheels 2 with respect to the base 13 changes according to the posture of the upper body of the standing user, and thus the user can move in a desired direction in the standing position. Furthermore, a difference in rotation speed of the pair of the left and right front wheels 2 enables turning, rotation on the spot, and the like.

The rear wheels 3 are trailing wheels and are attached to be turnable. By configuring the rear wheels 3 as tunable wheels, the mobile apparatus 1 can be brought in proximity to an object on which the user wants to sit, such as a chair or a bench.

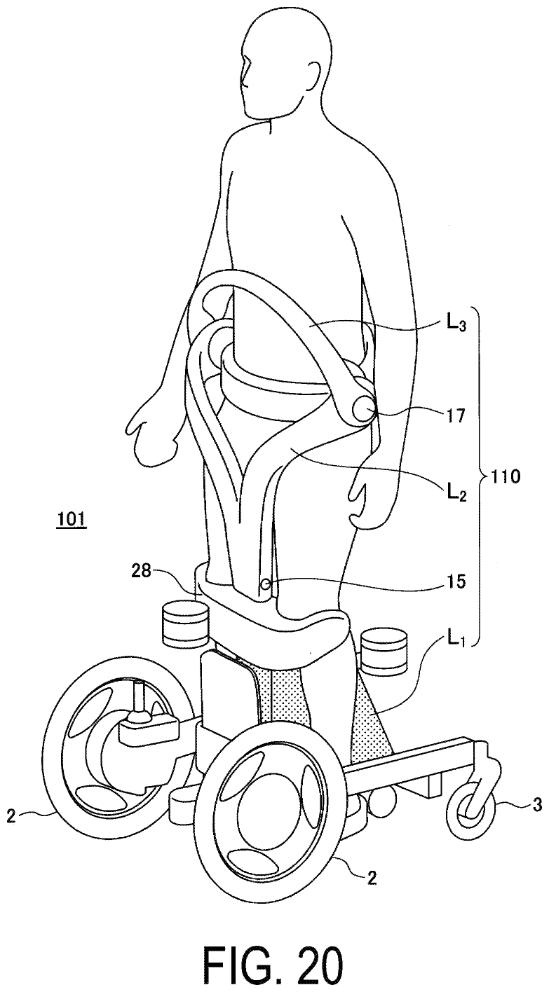

FIG. 20 is a diagram illustrating a user on board in a standing position. The user is standing having the first link L₁ fixed to the base 13 between his or her feet. In this example, the knee joint support member 28 is used. The knee joint support member 28 may include the part 18 illustrated in FIGS. 18 and 19. The second link L₂ coupled to the first link L₁ by the rotation node 15 is, for example, a Y-shaped link. The two branches of the Y shape extend towards both sides of the waist of the user and are coupled to the third link L₃ by the rotation node 17 at each of the branch ends. The third link L₃ is, for example, a U-shaped link.

When the user has a standing position from a sitting position, the rotation node 15 rotates as the magnitude relationship with the support moment changes according to the change in load from the user to support the user with the standing movement. At this time, the third link L₃ is synchronized with the second link L₂ to stably support the lower torso of the user.

As illustrated in FIG. 20, when a second Y-shaped link is used, the actuator 14 may be connected to each of the branches of the Y shaped or one actuator may be provided at the branch point. A shape of the second link L₂ is not limited to a Y shape, and it may be a U shaped, an arch, or the like, and it may not have a branch.

A support mechanism 110 that supports a user with posture transforming operates in accordance with a change in the balance between the support moment from the actuator 14 (see FIG. 18) and the load moment from the user, and does not require power supply or external control. A support operation in a standing or seating direction is induced depending on whether the sum of the support moment determined uniquely by a posture of the knee joint q2 and the load moment from the user resisting the support moment is directed to the standing direction or the seating direction. Further, in the design stage, a type, disposition, etc. of the actuator 14 are calculated so that the load moment from the user is predicted and an appropriate support moment is generated based on the predicted moment.

On the other hand, although not illustrated in the drawings, the mobile apparatus 101 is provided with a drive mechanism that drives the front wheels 2 and a controller for movement control. As an example, an in-wheel motor that drives the front wheels 2 directly by a motor provided in the vicinity of the front wheels 2 may be provided.

The support mechanism 110 may be combined with not only the mobile apparatus 101 in the configuration of FIG. 20, but also with an in-wheel motor system for standard wheelchairs. Instead of being fixed to the base 13, the first link L₁ may be fixed to a support body (such as a chassis) of a mobile body to be applied. The support mechanism 110 needs not necessarily be applied to a mobile body, and may be fixed to a non-moving platform or the like to perform support operations. In such a case, an optimal support force is transmitted to the user according to the load applied to the support mechanism 110 by a posture transition of the user.

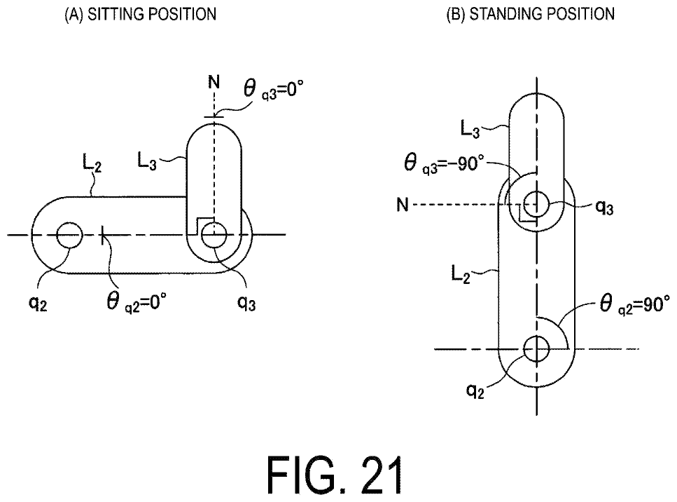

FIG. 21 is a diagram for describing coordinate systems of q2 and q3 for the support mechanism 110. q2 corresponds to the knee joint of the user and may be assumed to be a rotation axis of the rotation node 15. q3 corresponds to the waist joint of the user and may be assumed to be a rotation axis of the rotation node 17.

In the description below, an “angle of q2” refers to an angle of the line segment connecting q2 and q3 on the second link L₂ with respect to the horizontal line, and corresponds to the knee joint angle θₖ of the first embodiment. An “angle of q3” refers to an angle formed by a vertical line to the line segment connecting q2 and q3 and the trunk center line of the user held by the third link L₃.

In the case of the sitting position in (A) of FIG. 21, the second link L₂ of the support mechanism 110 is substantially horizontal with the horizontal line or the movement surface, and the third link L₃ has been raised substantially vertically with respect to the horizontal line. Assuming that the trunk center line or torso of the sitting user is nearly vertical, the angle θ_{q2} of q2 is 0 degrees and the angle θ_{q3} of q3 is 0 degrees.

In the standing position in (B) of FIG. 21, the second link L₂ of the support mechanism 110 has been raised substantially vertically with respect to the horizontal line or the movement surface, and the third link L₃ is also positioned substantially vertically with respect to the horizontal line. Assuming that the trunk center line or torso of the standing user is nearly vertical, the angle θ_{q2} of q2 is 90 degrees and the angle θ_{q3} of q3 is −90 degrees.

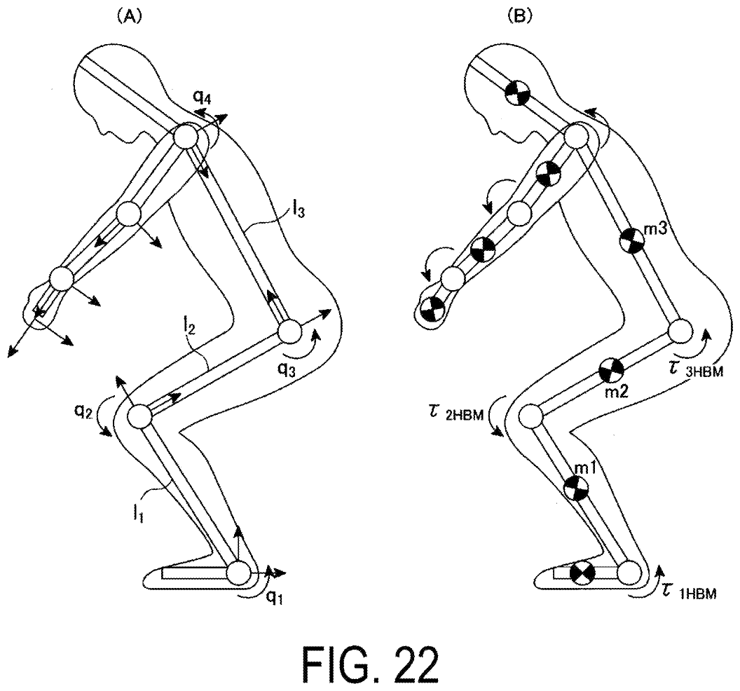

FIG. 22 is a human body model for describing the principle of the support mechanism 110 of the embodiment. FIG. 22 (A) illustrates an ankle joint q1, a knee joint q2, a waist joint q3, and a shoulder joint q4 when a position transitions from a sitting position to a standing position or from a standing position to a sitting position, and links l₁, l₂, and l₃ connecting the joints. FIG. 22 (B) illustrates the centroids (m1 to m3) of each of the links and the moments (τ_{1HBM} to τ_{3HBM}) acting on each of the joints.

Generally, movements of the ankle joint q1, the knee joint q2, and the waist joint q3 are focused in order to support users with a paralyzed leg with standing or seating movements. In contrast, in this embodiment, movements of the body above the knee joint q2 are considered with the ankle joint q1 fixed.

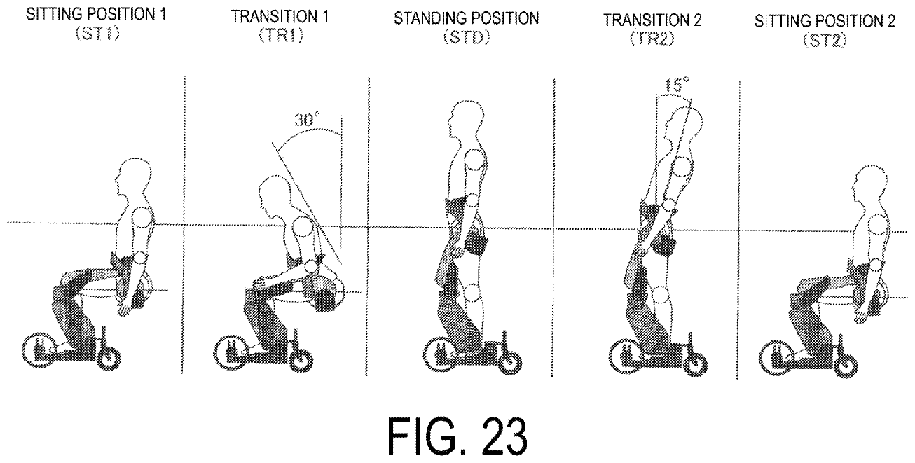

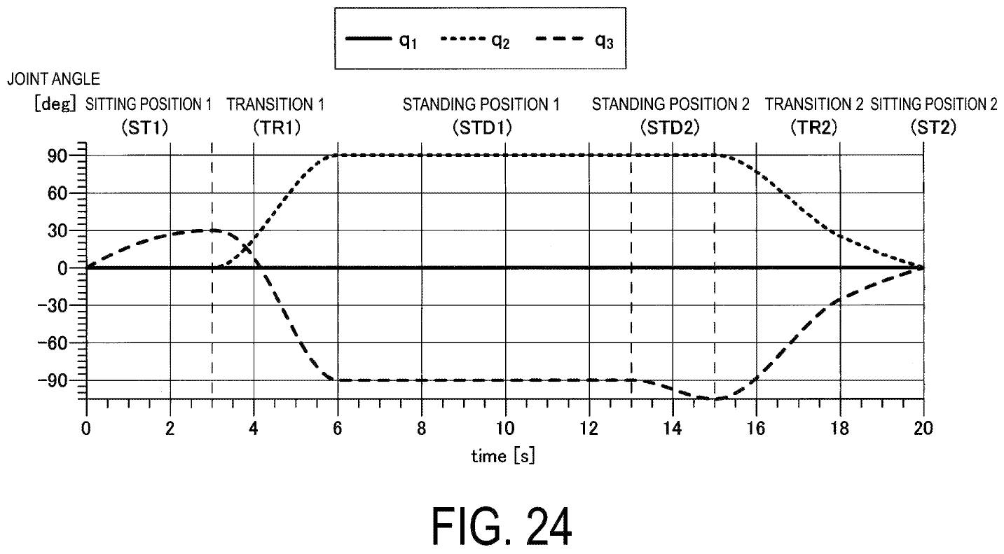

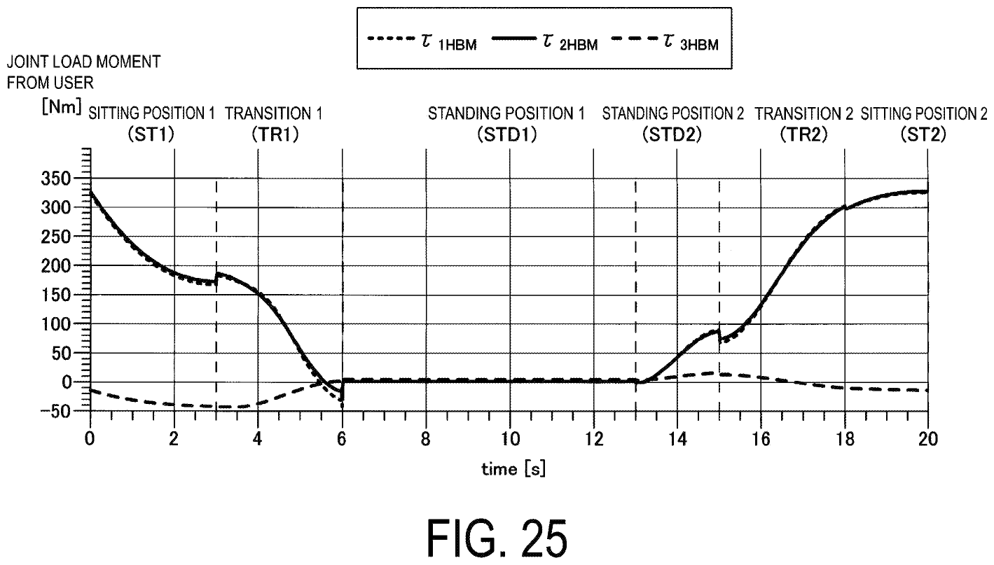

FIG. 23 illustrates a cycle of a posture transition of a user. FIGS. 24 and 25 show changes in the joint angle and load moment applied around the joint according to the posture transition of FIG. 23. In FIG. 23, the user transitions his or her posture to a sitting position (ST1), transition 1 from the sitting position to a standing position (TR1), a standing position (STD), transition 2 the standing position to a sitting position (TR2), and the sitting position (ST2). In FIG. 24, unlike known techniques, the angle of the ankle joint q1 is not taken into account, and the changes in the angles of the knee joint q2 and the waist joint q3 corresponding to the posture transitions are considered.

Referring to FIGS. 23 and 24, in the sitting positions (ST1 and ST2), the angle formed by the line segment connecting the knee and waist joints of the user and the horizontal line is approximately 0 degrees, and thus the trunk center of the user is substantially perpendicular to the horizontal plane. In the coordinate system of FIG. 21, the angle of q2 is 0 degrees and the angle of q3 is 0 degrees.

When the user attempts to stand up from the sitting position (TR1), although the user tilts his or her upper body forward, in the initial phase, the angle of the line segment connecting the knee joint q2 and the waist joint q3 does not change (q2 is constant). On the other hand, the trunk center line of the user changes within the forward tilt angle from the vertical line (up to 30 degrees), and the angle of q3 changes.

In the standing position (STD), the upper body of the user (trunk center line) is substantially vertical. The second link L₂ is raised substantially vertically with an angle of q2 of 90 degrees and an angle of q3 of −90 degrees.

When the user attempts to be seated from the standing position (STD2), the user first tilts his or her upper body backward and the trunk center line changes within the backward tilt angle (up to 15 degrees backward) from the vertical line. At this time, the angle of q3 changes from −90 degrees in the negative direction. On the other hand, because there is no change in the positions of the knee joint q2 and the waist joint q3, the angle of q2 remains at 90 degrees. In the next phase (TR2), the angle of q2 decreases from 90 degrees and the angle of q3 changes in the positive direction because the user bends his or her knee to be seated.

When the user is completely seated (ST2), the user returns to the initial state of the posture transition cycle, the angle of q2 is 0 degrees and the angle of q3 is 0 degrees.

In FIG. 25, the moment τ_{1HBM} around the ankle joint and the moment τ_{2HBM} around the knee joint are deemed as being approximately equal, and thus the moment τ_{2HBM} around the knee joint is focused on. When the user attempts to stand up from the sitting position, the moment τ_{2HBM} around the knee joint q2 is temporarily maximized in the first half of the transition 1 (TR1). Thereafter, as the knee joint q2 extends, the moment τ_{2HBM} decreases. On the other hand, the moment τ_{3HBM} around the waist joint q3 increases slightly toward zero as the user gets in the standing position. In the standing position (STD), the moment τ_{2HBM} and the moment τ_{3HBM} are approximately zero.

When the user attempts to be seated, the moment τ_{2HBM} increases as the user bends his or her knees. On the other hand, the moment τ_{3HBM} around the waist joint changes gradually in the negative direction.

In the embodiment, in order to reduce the total moments required for the standing position, the forward tilt angle of the torso is utilized for the standing movement, and the backward tilt angle of the torso is utilized for the seating movement.

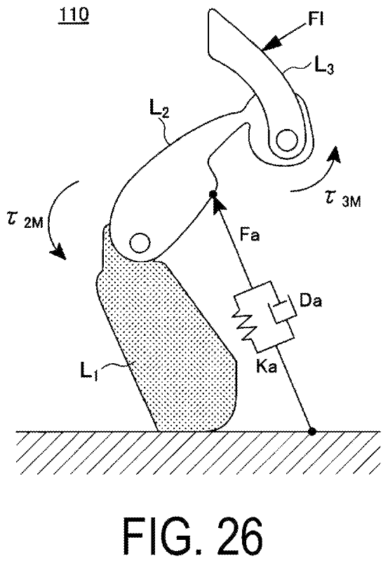

FIG. 26 is a model of power generation by the actuator 14 of the support mechanism 110. The actuator 14 provides power to the support mechanism 110 to support posture transforming. τ_{2M} in the figure represents a support moment applied to the knee joint of the user, and τ_{3M} represents a support moment applied to the waist joint of the user. An effective force Fa of the actuator 14 is determined depending on a spring coefficient Ka of the spring and a damping coefficient Da of the damper.

When the balance between the moment generated by the actuator 14 and the load from the user is changed, the second link L₂ pivots. The third link L₃ pivots accordingly.

The actuator 14 is designed such that an effective moment τₐ generated by the actuator 14 is greater than the load moment from the user when the user stands up in the standing movement of FIG. 25 (the transition 1 from a time t3 to a time t6). In addition, while the user takes a backward tilting position to make the seating movement (from a time t13 to a time t20), the moment τₐ generated by the actuator 14 is smaller than the load moment from the user. This effective moment τₐ may be referred to as a “support moment”.

In order to cause the user to make a standing movement, the actuator 14 causes a support moment exceeding a load moment τ_{load} applied to the support mechanism 110 from the user to be generated at the connection part of the first link L₁ and the second link L₂ (τₐ>τ_{load}).

On the other hand, the actuator 14 is designed such that the support moment τₐ by the actuator 14 is smaller than the load moment τ_{load} from the user applied to the support mechanism 110 (τ_{load}>τₐ) at the time before the user starts the forward tilting posture for the standing position (at a time t0) and during the seating movement (t15 to t20). This allows the user to make standing and seating movements at his or her own will.

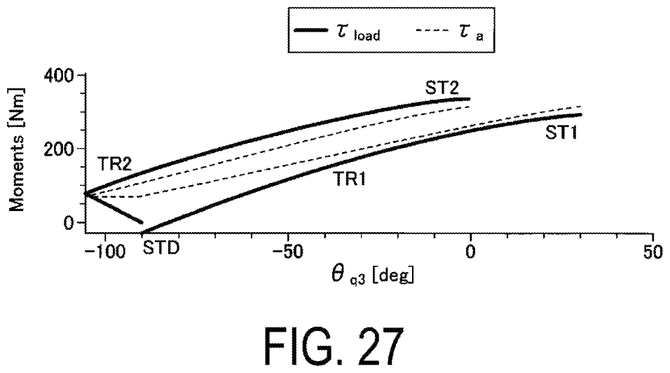

FIG. 27 shows the magnitude relationship of the moment applied to the knee joint when a movement for posture transforming is made. The horizontal axis represents an angle θ_{q3} of q3, and the vertical axis represents a moment (Nm) applied to the knee joint. As described above, θ_{q3} is an angle formed by a vertical line of the line segment connecting the knee joint q2 and the waist joint q3 and the trunk center line of the user. The solid line represents a moment τ_{load} from the user, and the dashed line represents an effective support moment τₐ applied by the actuator 14.

In one cycle, in the entire section (TR1) in which the user transitions from the sitting position (ST1) to the standing position (STD), the support moment (τₐ) from the actuator 14 is greater than the load moment τ_{load} from the user and changes according to the angle of the knee joint q2. In the course in which the user takes a forward tilting posture for the standing position, the angle θ_{q3} changes from 30 degrees to 0 degrees and, in the course in which the user stretches and raises his or her knees, θ_{q3} changes from 0 degrees in the negative direction.

When the user stands up completely (STD), the angle θ_{q3} becomes −90 degrees. In the course in which the user tilts backward to make the seating movement from the standing state, the angle θ_{q3} changes from −90 degrees to −105 degrees. The support moment (τₐ) is greater than the load moment τ_{load} from the user until the user tilts backward from the vertical position to have a backward tilt angle of 15 degrees.

When the user tilts his or her upper body backwards by 15 degrees and the angle θ_{q3} reaches −105 degrees, the load moment from the user (τ_{load}) is greater than the support moment (τₐ) by the actuator 14, the relationship in which τ_{load} is greater than τₐ is maintained in all sections while the user transitions from the standing position to the sitting position (ST2), and the support moment τₐ changes according to the angle of the knee joint q2 of the user.

As a result, the user can move his or her upper body in the standing and seating movements at his or her own will by controlling the equilibrium between the load moment acting on the knee joint and the support moment by the support mechanism 110, and thus the user can transform his or her posture. The user can stop and resume his or her movement in any posture during the posture transforming movement.

Even a user who is not able to voluntarily control his or her lower body or a user with the disabled trunk lower part can autonomously move his or her upper body by himself or herself to change a posture between sitting and standing positions. Because the support mechanism 110 needs no supply of power and control device and supports posture transforming based on movement of the upper body of the user, it is also suitable for supporting standing and seating movements in rehabilitation training for users with a limited lower limb motor function due to spinal cord injuries, strokes, cerebral paralysis, and the like.

Although a user has 30 degrees of freedom from the vertical line to forward in the sitting position and has 15 degrees of freedom from the vertical line to backward in the standing position in the design example, degrees of freedom are not limited to this example. Although the characteristics of the moment of FIG. 27 enable users with a height of 180 cm and a body weight of 80 kg to be supported, characteristics of the moment generated by the actuator 14 can be optimized according to a state of a height, a body weight, the lower limbs of the user, etc. In this case, the configuration of FIG. 17 in the first embodiment may be used.

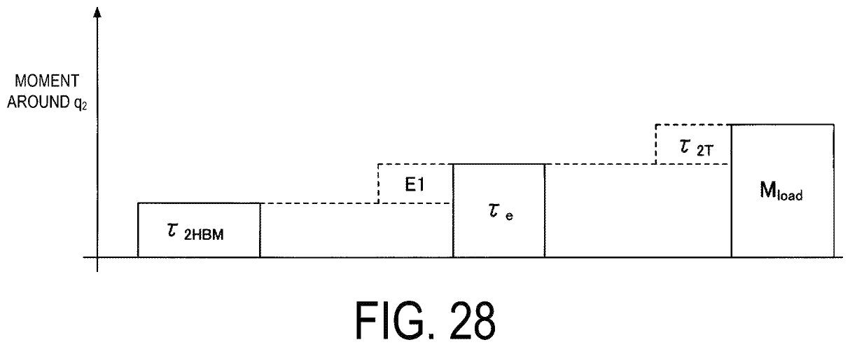

FIG. 28 is a diagram for describing a moment τₐ generated by the actuator 14. Each bar graph is displayed for each type of moment τₐ, and the vertical axis represents a magnitude of a moment around q2. “τ_{2HBM}^{”} on the left end of the horizontal axis represents a moment required for the knee joints of a healthy person when he or she stands up or sits. “τₑ” at the center of the horizontal axis represents a moment to be generated by the actuator 14 around the knee joints such that a moment equivalent to τ_{2HBM} is obtained after taking the outer skeletal mass and friction effects into account and offsetting the factor E1 of the elements.

“M_{load}” on the right end of the horizontal axis represents a total moment to be generated by the actuator 14 considering a load applied to the support mechanism 110 from the user. The moment applied to the waist joint q3 when the user leans against the third link L₃ affects the moment of q2. The reason for this is that the force transmission system described below transmits a force to q2 and q3. Therefore, the moment effect τ_{2 T} generated between the third link L₃ is further added to generate a moment (M_{load}) required for the entire system.

Here, the sizes of the bar graphs representing τ_{2HBM}, τₑ, and M_{load} in FIG. 28 do not represent the actual size ratios in the example. In addition, E1 and τ_{2T} may take a negative value depending on conditions of movements, and may have a magnitude relationship that τₑ is greater than M_{load}.

M_{load} corresponds to the support moment τₐ in FIG. 27. Similar to the support moment τₐ, the support mechanism 110 is designed such that the τ_{2T} monotonically increases or monotonically decreases (linearizes) with respect to the angle of the knee joint q2. τ_{2T} affects two elements including

(a) what change in posture or angle q3 (the waist joint) is made while the angle of q2 (the knee joint) changes in the range from 0 degrees and 90 degrees; and

(b) how the moment τ_{3HBM} around q3 generated by the user leaning against the third link L₃ is transmitted to q2.

The element (a) is as described with reference to FIGS. 23, 24, 26, and 27. The support moment τₐ generated by the actuator 14 is distributed to a support moment applied to the knee joint of the user (which is denoted by τ_{2M}), a support moment applied to the waist joint (which is denoted by τ_{3M}), and the factor E1 such as loss due to a weight of the apparatus, and the like. The support moment τ_{3 m} to the waist joint is transmitted by multiplying the distributed moment by a magnification of the force transmission mechanism between the second link L₂ and the third link L₃. The load moment τ_{load} acting on the actuator 14 is the sum of the knee joint load moment τ_{2HBM}, the load moment from the waist joint (referred to as τ_{2T}), and the factor E1, such as loss due to a weight of the apparatus. The waist joint load moment τ_{3HBM} acts on the actuator 14 as τ_{2T} through a magnification of the force transmission mechanism between the second link L₂ and the third link L₃. Transmission of a force will be described below.

Force Transmission System

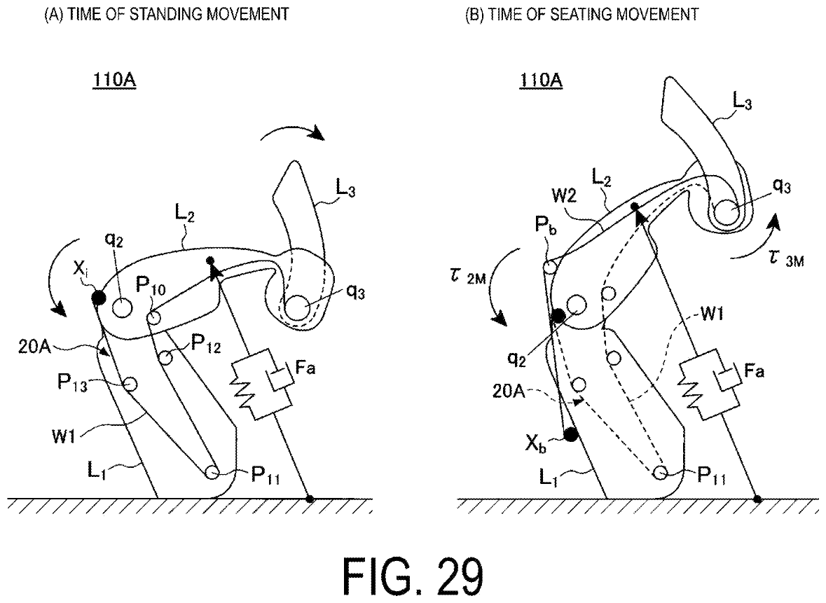

FIG. 29 illustrates a configuration example of a force transmission system 20A of a support mechanism 110A of the embodiment. In this example, a plurality of pulleys P and wires W1 and W2 are used to configure the force transmission system 20A. Power for posture transforming is supplied to a second link L₂ by an actuator 14 such as a gas spring. During a posture transition, a moment generated by the actuator 14 around a knee joint q2 is transmitted by the wire transmission to the third link L₃ to synchronize motions of the knee joints and torso.

When a Y-shaped second link L₂ is used as in FIG. 20, two wires W1 and W2 are disposed on the portion of the second link L₂ corresponding to the right femur, and two more wires W1 and W2 are disposed on the portion corresponding to the left femur, and thus four wires in total are used. The two sets of wires are disposed on the branches of the Y shape to be horizontally symmetric.

To describe focusing on one set of wires W1 and W2, one of the two wires (e.g., W1) rotates the third link L₃ clockwise and another wire (e.g. W2) rotates the third link L₃ counter-clockwise.

In the standing movement in FIG. 29(A), the second link L₂ rotates counterclockwise to extend. Here, the “extension” refers to a posture change in which the first link L₁ and the second link L₂ are on a straight line or in a posture close to a straight line. A distance between the fixed point Xᵢ of the wire W1 and a pulley P₁₃ and a distance between a pulley P₁₀ and a pulley P₁₂ depend on an angle formed by the first link L₁ and the second link L₂. When the second link L₂ extends, the distance between the wire fixed point Xᵢ and the pulley P₁₃ becomes shorter, and the distance between the pulley P₁₀ and the pulley P₁₂ becomes longer. As a result that the wire W1 is displaced within the second link L₂, the third link L₃ (and the rotation axis corresponding to the waist joint q3) moves clockwise.

Here, the wire path from Xᵢ to P₁₃ and the wire path from P₁₀ to P₁₂ are set such that the third link L₃ is moved forward in the range of 30 degrees with respect to the normal of the longitudinal axis of the second link L₂ (q3=30 degrees) and moved backward in the range of 90 degrees (q3=−90 degrees).

In the seating movement in FIG. 29(B), the second link L₂ rotates clockwise to bend. Here, the “bending” refers to a posture change in the direction opposite to the extension. A distance between a wire fixed point X_{b} of the wire W2 and a pulley P_{b} depends on an angle formed by the first link L₁ and the second link L₂. The bending of the second link L₂ increases the distance between the wire fixed point X_{b} and the pulley P_{b}. As a result that the wire W2 is displaced within the second link L₂, the third link L₃ (and the rotation axis corresponding to the waist joint q3) moves counterclockwise.

The wire path between X_{b} to P_{b} continuously changes while the torso of the user is completely supported in the range from −105 degrees of the rear limiter of the waist joint q3 (15 degrees from vertical to rear sides, q3=105 degrees and q2=90 degrees) to 0 degrees (vertical due to a sitting posture, q3=0 degrees, and q2=0 degrees) as the angle of the knee joint q2 transitions from 90 degrees (in a standing posture) to 0 degrees (in a sitting posture).

The grooves on the pulley circumference on the q3 axis holding the wires W1 and W2 to drive q3 may have different radii set for the respective wires. In this case, it is possible to support the asymmetrical posture in the standing and seating movements. Even if the moment τ_{3HBM} generated around q3 is the same, the magnitude of the τ_{2T} (see FIG. 28) affecting the knee joint q2 differs depending on the sorted paths of the wires W1 and W2. Therefore, the diameter of the pulley provided at a position corresponding to q3 is optimally designed.

The force transmission system 20A linearizes the influence on q2 (τ_{2T}) due to the force from the user applied to the third link L₃ (the load variation with respect to the angular change of the waist joint q3 monotonically increases or decreases) and minimizes the load on the actuator 14. The force transmission system 20A can be used to linearize the load moment acting on a single actuator and synchronize motions of the knee and waist joints of a user.

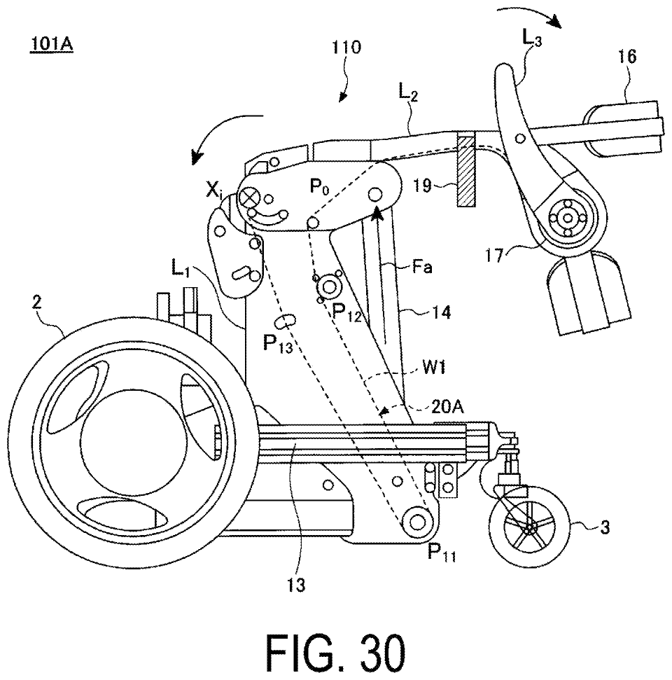

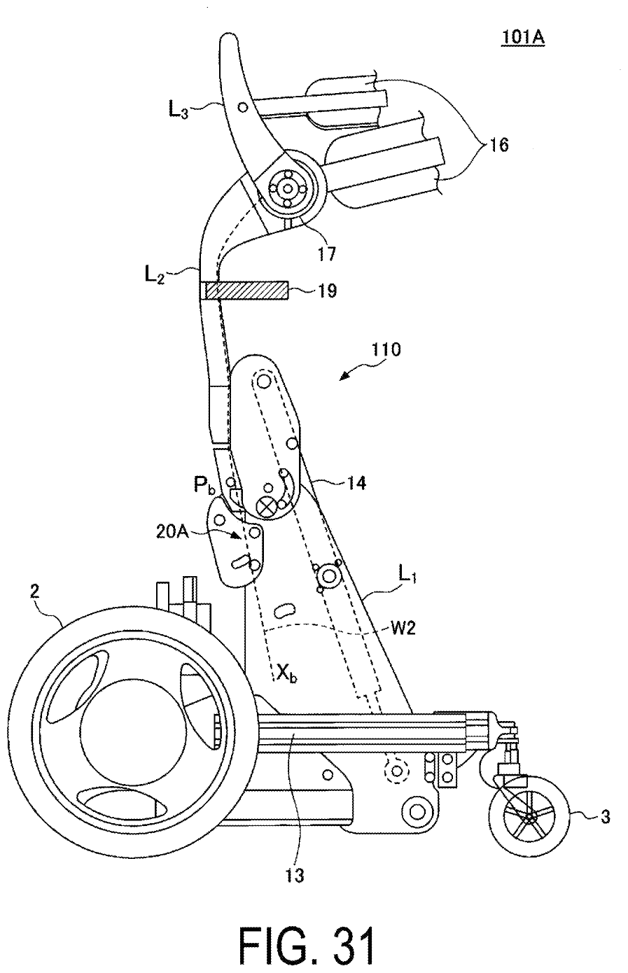

FIGS. 30 and 31 are schematic views of a mobile apparatus 101A having the force transmission system 20A of FIG. 29. FIG. 30 shows a sitting state, and FIG. 31 shows a state in which a user moves in a standing position.

In FIG. 30, the force transmission system 20A is coupled to a third link L₃ through the inside of a first link L₁ and a second link L₂ of a support mechanism 110. When the user stands up from the sitting position, the third link L₃ receives an action of the actuator 14 for driving the knee joint through the path of a wire W1 from Xᵢ to P₁₃ and a path from P₀ to P₁₂.

In FIG. 31, when the user transitions from the standing position to the sitting position, the third link L₃ receives an action of the actuator 14 through the path of a wire W2 from X_{b} to P_{b}. This configuration synchronizes motions of the knee joint and the torso of the user in a posture transition.

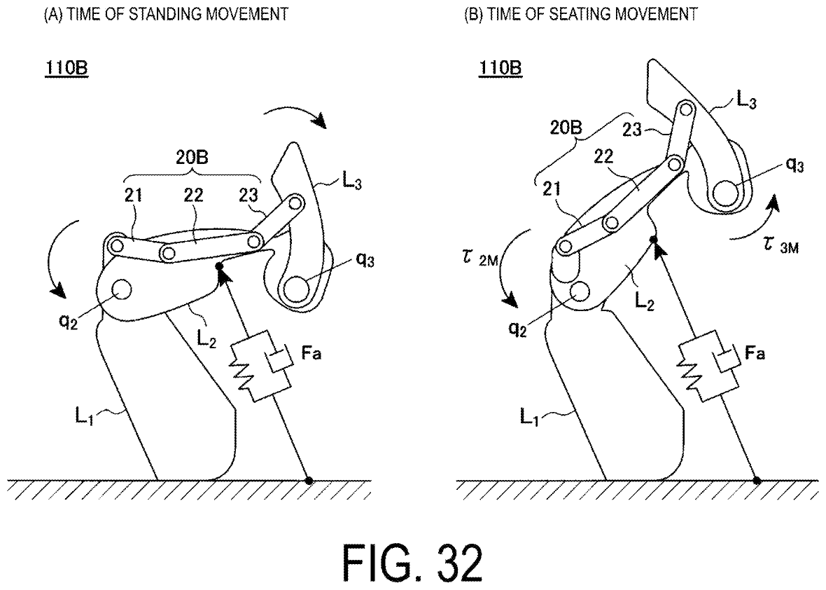

FIG. 32 illustrates a configuration example of a support mechanism 110B using a force transmission system 20B of the embodiment. In this example, a plurality of transmission rods 21, 22, and 23 are used to configure the force transmission system 20B. Power for supporting posture transforming is supplied to a second link L₂ by an actuator 14 such as a gas spring. During a posture transition, a force generated by the actuator 14 around a knee joint q2 is transmitted by the transmission rods 21, 22, and 23 to the third link L₃ from the second link L₂ to synchronize motions of the knee joint and torso.

One end of the transmission rod 21 is attached to the first link L₁. The transmission rod 22 is constrained to slide in parallel to the longitudinal axis direction of the second link L₂, and the transmission rod 22 is connected to the first link L₁ via the transmission rod 21. One end of the transmission rod 23 is attached to the third link L₃, and the transmission rod 22 is connected to the third link L₃ via the transmission rod 23. The force transmission system 20B using the transmission rods 21, 22, and 23 drives the third link L₃ in response to angular changes of q2 corresponding to the knee joint.

In the case where the Y-shaped second link L₂ is used as in FIG. 20, at least some of the transmission rods 21 to 23 constituting the force transmission system 20B is caused to branch to provide transmission links to the portion corresponding to the right thigh and the portion corresponding to the left thigh.

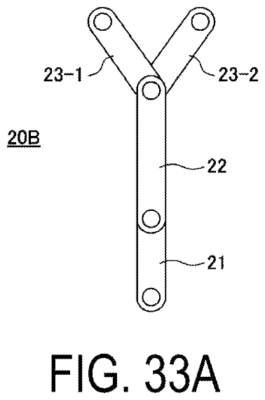

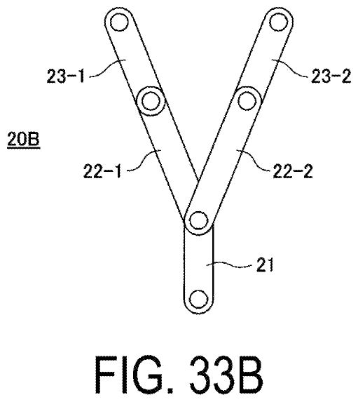

In FIG. 33A, a transmission rod 23-1 and a transmission rod 23-2 are commonly coupled to the transmission rod 21 and the transmission rod 22, corresponding to the branch portions of the second link L₂. In FIG. 33B, the transmission rod 21 is commonly used for transmission rods 22-1 and 23-1 and transmission rods 22-2 and 23-2 to correspond to the branch portions of the second link L₂.

A length of each transmission rod and the positions of the fulcrum and force point are set to linearize a load from the user applied to the third link L₃ to monotonically increase or decrease the load moment applied by the actuator 14 and minimize the load applied to the actuator 14.

A configuration of the force transmission system is not limited to the wire-pulley configuration of FIG. 29 and the transmission rod configuration of FIG. 32. For example, a bevel gear may be used to transmit moments. In this case, by appropriately selecting a gear ratio of the bevel gear, the relationship between the moment τ_{3HBM} around the waist joint q3 and the moment transmitted from q3 to q2 can be adjusted so as to linearize the effect on q2 (or τ_{2T} in FIG. 28) due to a force of the user imposed on the third link L₃.

Control of Mobile Apparatus

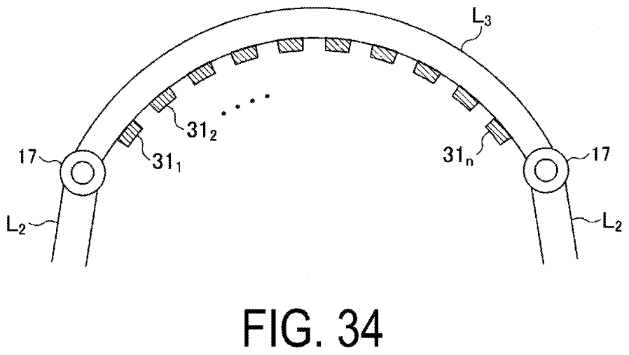

FIG. 34 illustrates a disposition example of pressure sensors 31 disposed on the third link L₃. Pressure sensors 31₁ to 31ₙ are disposed on, for example, an inner side of the third link L₃ (the side on which the third link comes in contact with the user) to use the third link L₃ as an operation interface.

The primary role of the third link L₃ is to stably support the upper body of a user in a standing position at the time of posture transforming. For this reason, the third link L₃ is shaped so as to be easily brought into contact with the upper body of the user, in particular, around his or her abdomen. Contact of the third link L₃ with the upper body of the user is used to control a traveling direction and a speed of the mobile apparatus 101.

When a user moves in a standing position, the lower limbs and torso of the user are supported by the first link L₁, the second link L₂, and the third link L₃ of the support mechanism 110 as illustrated in FIG. 20, and thus the user can operate the mobile apparatus 101 without using hands by moving his or her weight.

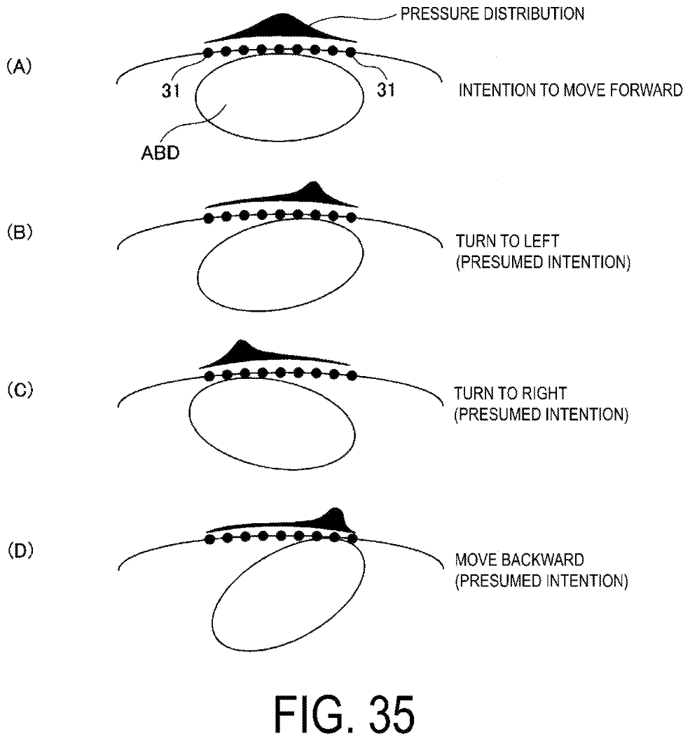

As illustrated in FIG. 35, the path direction and speed can be controlled based on the pressure distribution obtained by the pressure sensors 31₁ to 31ₙ. For example, a controller or processor can be disposed on the base 13 of the mobile apparatus 1 to collect and process the output of the pressure sensors 31₁ to 31ₙ to obtain a pressure distribution. The path direction and speed can be calculated using the pressure distribution, and the rotational speed of the front wheels 2 can be controlled.

In (A) of FIG. 35, when the abdominal region of the user is located evenly the third link L₃, the pressure distribution obtained from the plurality of pressure sensors 31 has a peak shape with a maximum value. In this case, the controller or the processor determines that the intention of the user is “to move forward” and causes the front wheels 2 to rotate at an equal speed. In addition, the height of the peak of the pressure distribution also enables to estimate the movement speed intended by the user.

In (B) of FIG. 35, if the torso of the user is twisted to the left, the pressure distribution shifts to the right as a whole. In this case, the controller or the processor determines that the presumed intention of the user is “to turn to the left” and then causes the right front wheel 2 to rotate faster than the left front wheel 2 to direct the traveling direction of the base 13 to the left. In addition, the peak bias (a shift amount) of the pressure distribution enables to estimate the amount of turn intended by the user.

In (C) of FIG. 35, if the torso of the user is twisted to the right, the pressure distribution shifts to the left as a whole. In this case, the controller or the processor determines that the presumed intention of the user is “to turn to the right” and then causes the left front wheel 2 to rotate faster than the right front wheel 2 to direct the traveling direction of the base 13 to the right. In addition, the peak bias (a shift amount) of the pressure distribution enables to estimate the amount of turn intended by the user.

In (D) of FIG. 35, if only a slight portion near a side abdomen of the user is in contact with the third link L₃, i.e., the pressure distribution is limited to a very narrow area, the controller or processor determines that the presumed intention of the user is “to move backward”. In such a pressure distribution, the user is generally attempting to move backward while looking back. In this case, the rotation direction of the front wheels 2 is switched.

The number, intervals, and the like of the pressure sensors 31 to be used are appropriately determined according to a body form of the user. The user can intuitively operate the mobile apparatus by twisting his or her torso in a standing posture.

An angle sensor may be provided in the second link L₂ and the third link L₃ so that the output of the angle sensor can be input to the controller or the processor. When the second link L₂ and the third link L₃ are not in a standing position, a brake mechanism may be set to work.

The force transmission systems 20A and 20B of the second embodiment linearize the load τ_{2 T} applied to the actuator from the upper body of the user in his or her knee joint posture when a movement of a single joint (knee joint) is supported by the single actuator 14.

The actuator 14 generates the support moment τₙ greater than the load from the user applied to the support mechanism 110 in the entire range of standing movements and changes the support moment τₐ according to extension of the knee joint q2.

The actuator 14 generates the support moment τₐ smaller than the load from the user applied to the support mechanism 110 in the entire range of seating movements and changes the support moment τₐ according to bending of the knee joint q2.

By providing the force transmission system between q2 and q3, the second link L₂ and the third link L₃ can be synchronized to naturally interlink the knee and waist joints of the user.

In a standing movement, a posture of the upper body of a user is allowed to have up to a predetermined forward tilt angle θ1, and in a seating movement, a state of a user is allowed to have up to a predetermined backward tilt angle θ2. A magnitude of the allowable forward tilt angle for standing and a magnitude of the allowable backward tilt angle for seating may differ.

The support mechanism 110 (including the support mechanisms 110A and 110B) of the embodiments can stably support the upper body of a user in a posture transition from sitting to standing, from standing to sitting, etc.

An upright mobile apparatus 101 can be provided using the support mechanism 110 as an alternative to existing wheelchairs that are used in sitting postures. The mobile apparatus 101 can be operated without using hands. The support mechanism 110 of the embodiment is also suitable as a rehabilitation device for patients in a recovery process from stroke, lower limb disease, etc.

### Third Embodiment

In a third embodiment, a single passive actuator is used to support users with posture transforming and elimination. A change in the load moment on the knee joint caused by a movement of the centroid of a user is utilized to generate an appropriate support moment in the passive actuator in order to support posture transforming of the user between sitting and standing positions, as in the first and second embodiments. Unlike the configurations of the related art, a single passive actuator generates only a support moment corresponding to a motion the knee joint of the user, which enables a configuration to be simplified, a weight of the apparatus to be reduced, and portability to be improved. In addition, a burden on the user at the time of posture transforming can be reduced.

A support mechanism to support elimination has a structure for primarily supporting the lower limbs of a user. The structure includes a plurality of links, some of which are driven by a passive actuator in response to extension and bending of the knee joints of the user. The structure is designed to support the thighs of the user from the back and to form a sufficient space around his or her hip. With the design in which constraints around the hip and further around the hipbone of a user are removed as far as possible, the user using the support mechanism of the third embodiment can put on or take off his or her pants by him or herself without aid of a caregiver while standing.

According to the embodiment, users including not only adults but also children, and adolescents can be targets of support. In view of promoting body development of children suffering from motor dysfunction in the lower limbs, it is important to support elimination that requires posture transforming between sitting and standing positions. A passive actuator that does not require supply of power can be used to cope with changes in the height and weight of the user in a certain range.

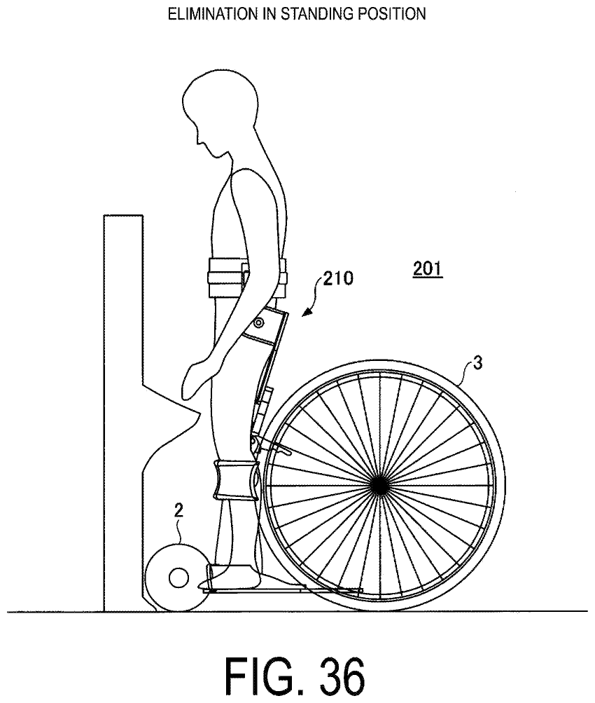

FIGS. 36 to 38 are diagrams for describing the basic concept of a support mechanism according to the third embodiment. Although a support mechanism 210 is configured as a mobile apparatus 201 in combination with front wheels 2 and rear wheels 3 in FIGS. 36 to 38, the support mechanism 210 may be used alone. If the support mechanism 210 is configured as the mobile apparatus 201 in the configuration of FIGS. 36 to 38, the user is assumed to move in a standing position. However, the support mechanism 210 can be combined with a standard wheelchair.

A male user can urinate in the same standing posture as that in movement as illustrated in FIG. 36. If auxiliary wheels or caster wheels are used as front wheels 2, the support mechanism 210 can easily approach a urinal while moving forward.

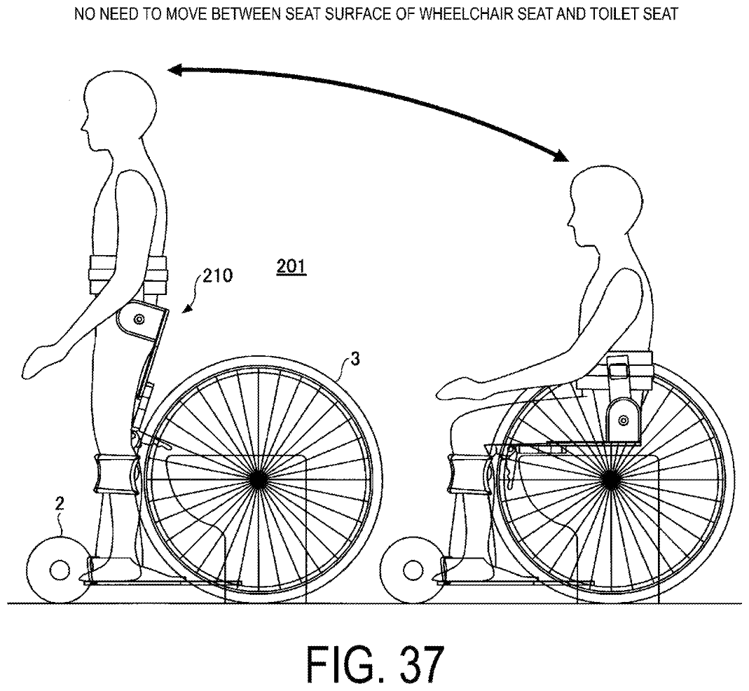

When a user using the support mechanism 210 wants to use a toilet seat as illustrated in FIG. 37, the user moves closer to the bowl while moving backward in the standing position. A rotation direction and orientation of the rear wheels 3 may be controlled based on control of a controller, a sensor output, a microprocessor, etc. The user who has approached the toilet seat while moving backward can sit on the toilet seat being aboard the support mechanism 210 using the posture transforming function of the support mechanism 210.

Unlike a common wheelchair, the user does not have to move between the seat surface of the wheelchair and the toilet seat. In addition, due to the link structure of the support mechanism 210, the user can raise up or lower down his or her pants by himself or herself after and before elimination. The details will be described below.

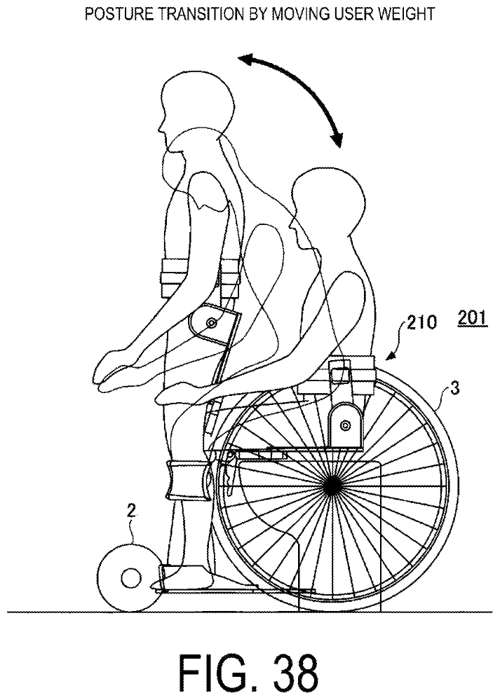

When a user transitions his or her position from a standing position to a sitting position using the posture transforming function of the support mechanism 210, the user has a backward tilting posture, and when the user transitions his or her position from a sitting position to a standing position, the user has a forward tilting posture as illustrated in FIG. 38. The change in centroid at this time can cause an appropriate support moment to be received from the passive actuator.

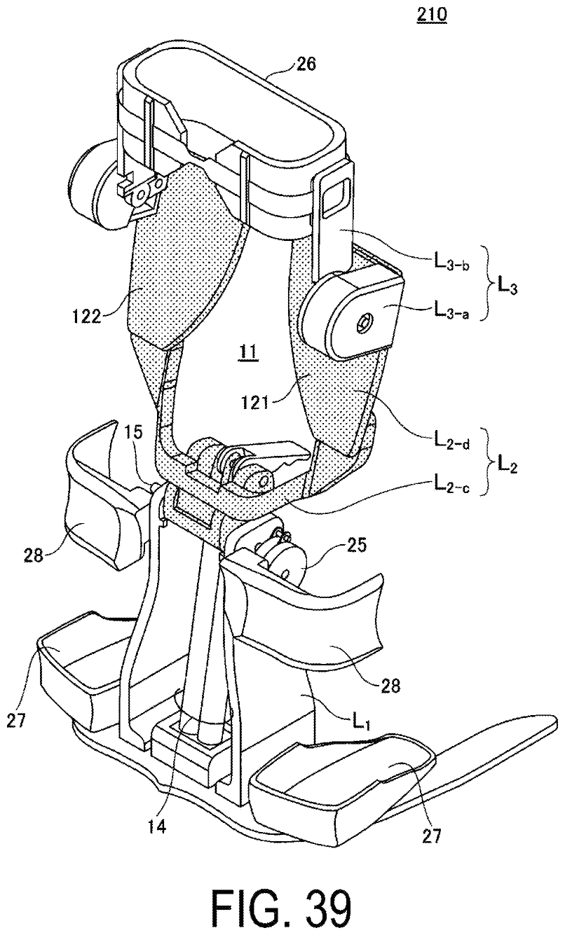

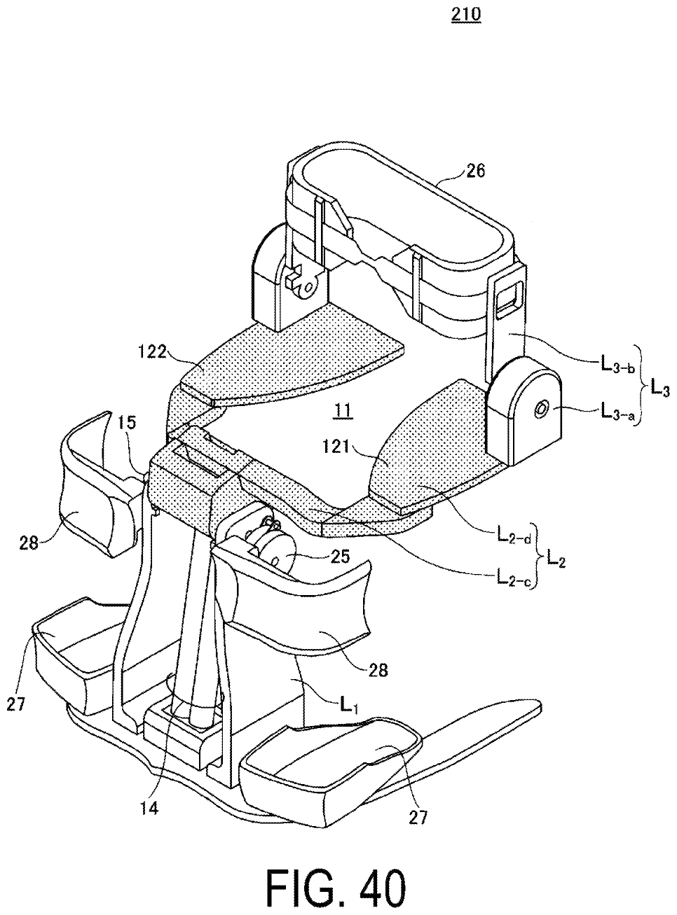

FIGS. 39 and 40 are perspective views of the support mechanism 210 with a posture transforming function of the third embodiment. FIG. 39 illustrates a standing state, and FIG. 40 illustrates a sitting state. The support mechanism 210 includes a first link L₁ in a fixed state, a second link L₂ that is rotatably coupled to the first link L₁, a third link L₃ coupled to the second link L₂, a torso belt 26 connected to the third link L₃, and an actuator 14 that rotates the second link L₂ with respect to the first link L₁.

The first link L₁ is a stationary link that has no posture change such as rotation, rocking, opening and closing, and the like. The second link L₂ can pivot in a predetermined angular range with respect to the first link L₁ by a rotation node 15. The rotation node 15 is formed, for example, as a rotating shaft, and rotates in response to a movement of the knee joints of a user.

The second link L₂ includes a rotating link L₂₋ₑ and a thigh support L_{2-d}. The rotating link L_{2-c} is coupled to the first link L₁. Further, the rotating link L_{2-c} is connected to one end side of the actuator 14 to receive a support moment for posture transforming from the actuator 14. The actuator 14 may be provided with a damper 25 for adjusting a moment and absorbing a shock. The damper 25 can be provided for smooth driving.

The thigh support L_{2-d} is connected to the rotating link L_{2-c} to support the thighs of the user from the back side when the user transforms his or her posture between sitting and standing positions. In this example, the thigh support L_{2-d} is formed as a pair of wings 121 and 122 extending from both ends of the rotating link L_{2-c}. The wings 121 and 122 are formed such that their width becomes gradually wide from the backside of the knees to just below the hip based on the shape of the thighs of the user to stably support the back side of his or her thighs when transitioning between the sitting and standing positions.

The pair of wings 121 and 122 are disposed such that a sufficient space 11 is formed therebetween. By providing the space 11, the hip and its surrounding parts of the user are released with little constraints.

The torso belt 26 is connected to the third link L₃ to stably support the user during the posture transforming without constraints around the hip. The third link L₃ has a base L₃₋ₐ that is coupled to the thigh support L_{2-d} and extends laterally from the back side of the thighs and an end L_{3-b} that extends upward from the base L₃₋ₐ along the side of the torso. The torso belt 26 is connected to the end L_{3-b} and fixes the torso of the user at a position higher than the waist bone of the user, or in some specifications, a position higher than the navel. This configuration can minimize constraints around the waist.

The third link L₃ and the torso belt 26 allow the user to stably transform posture without losing his or her posture. By providing the torso belt 26 at a higher position than the waist bone, it is easy for the user to put on and take off his or her pants or lower down and raise up his or her underwear at the time of elimination. The user can smoothly perform a series of actions of lowering down pants to sit on the toilet seat and then raising up the pants after that while his or her upper body is firmly supported by the torso belt 26.

The first link L₁ may be provided with a knee joint support member 28 that supports front knees of the user. In addition, a footrest 27 may be provided on both sides of the first link L₁. If a user has paralyzed lower limbs or the like so has difficulty having a standing position by himself or herself, the user needs the knee joint support member 28; however, the knee joint support member 28 may be omitted for a user such as an elderly person whose legs are somewhat weakened. By providing the footrest 27, it becomes easy to grasp the standing position when the support mechanism 210 is used, and the feet can be stabilized. The footrest 27 may also be omitted depending on the degree of disability of the user.

In the sitting state of FIG. 40, the entire second link L₂ having the rotating link L_{2-c} and the thigh support L_{2-d} is laid down to a horizontal angle from a direction close to perpendicular to the reference plane on which the support mechanism 210 is placed.

The second link L₂ is rotated by a passive movement of the actuator 14. When the user changes the posture of the upper body to transition between the sitting position and the standing position, the centroid position changes, and the load applied to the rotation node 15 connecting the first link L₁ and the second link L₂ varies. The actuator 14 generates a support moment in response to the fluctuations in the load, with fluctuations in the load from the user. The actuator 14 utilizes a force, such as that of a spring, to generate a support moment without supply of power.

Although a set of three gas springs is used as the actuator 14 in the examples of FIGS. 39 and 40, an appropriate elastic members such as viscoelastic dampers using liquid pressure, coil springs, rubber springs, and the like may be used. Even when a set of gas springs is used, they are a single actuator in the sense that they causes the second link L₂ to pivot with respect to the first link L₁. This significantly differs from the known art in which a first portion corresponding to an ankle joint and a second portion corresponding to a knee joint are driven by individual actuators.

Although the second link L₂ is shown in a gray pattern in order to facilitate clarity of the connection relationship between the first link L₁, the second link L₂, and the third link L₃ in FIGS. 39 and 40, all of the first link L₁, the second link L₂, and the third link L₃ may be formed of the same material. For example, they may be formed of plastic that is injection molded with a resin material with high mechanical strength and durability.

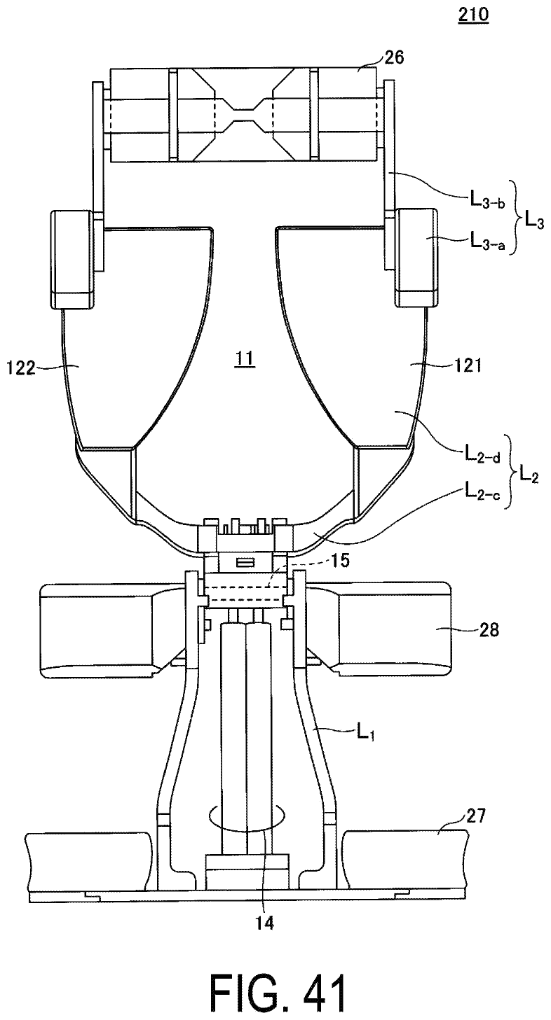

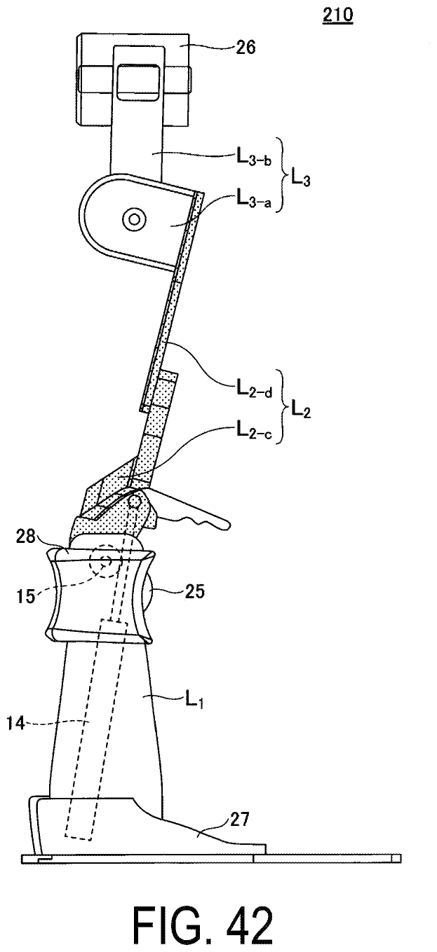

FIG. 41 is a front view of the support mechanism 210, and FIG. 42 is a side view of the support mechanism 210. FIGS. 41 and 42 also illustrate a standing state corresponding to FIG. 39. When the user uses the support mechanism 210, the user straddles both sides of the first link L₁. The lower limbs (legs) of the user are positioned between the knee joint support member 28 and the thigh support L_{2-d}.

In FIG. 41, the wings 121 and 122 constituting the thigh support L_{2-d} may have any shape as long as they can support the back side of the thighs during the posture transforming of the user and provide the sufficient space 11 around the hip. That is, it can have any shape in which the back side of the thighs of the user is held and elimination can be facilitated. For example, the plane shape can be an appropriate shape such as a U-shape, a fan-shape, a Y-shape, or a funnel-shape. A curved surface conforming to the shape of the thighs of the user may be formed on the support surface of the wings 121 and 122 in contact with the thighs of the user.

The base L₃₋ₐ of the third link L₃ is coupled to the lateral end of the thigh support L_{2-d} so as not to interfere with the supporting surface of the thigh support L_{2-d}. The end L_{3-b} of the third link L₃ is rotatably coupled to the base L₃₋ₐ. By allowing the end L_{3-b} to rotate with respect to the base L₃₋ₐ, even if the tilt angle of the upper body of the user fixed to the torso belt 26 changes when the user transforms his or her posture, the upper body of the user can be held without imparting a sense of compression or discomfort.

Although the torso belt 26 is, for example, a one-touch inset-type belt that is fastened on the front side, it is not limited to this example. Appropriate fasteners such as clasps, hooks, and Velcro (trade name) may be used as long as they can securely hold the upper body of the user. The torso belt 26 may be detachably connected to the end L_{3-b} of the third link L₃.

The actuator 14 needs not necessarily employ multiple gas springs. If a single gas spring can generate the support moment required for the support mechanism 210, the actuator 14 may be configured with a single gas spring.

As is clearly illustrated in FIG. 42, the angle of the second link L₂ increases to an angle of 80 degrees±5 degrees with respect to the horizontal plane for an upright upper body. The angle of the knee joint of 80 degrees is as close as possible to that of a normal standing posture, and is an angle at which a posture transition from a standing position to a sitting position can be easily performed, especially from a mechanical point of view. The inventors have designed and manufactured a prototype for an angle of 80 degrees ±5 degrees, and have confirmed that the user can stand in a natural posture and easily transition from a standing position to a sitting position. The second link L₂ is rotationally driven in an angular range from 0 degrees to 80 degrees by the actuator 14.

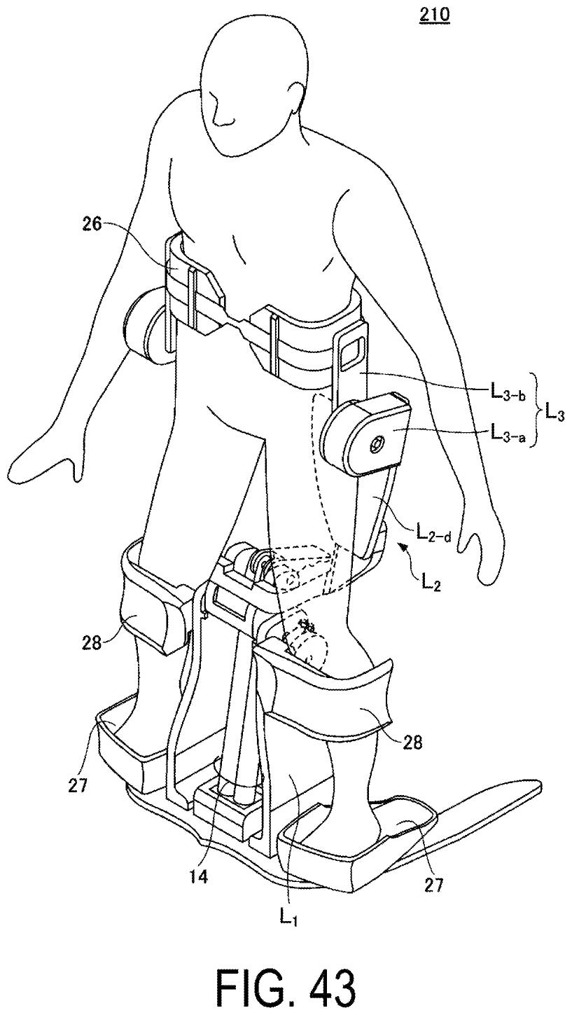

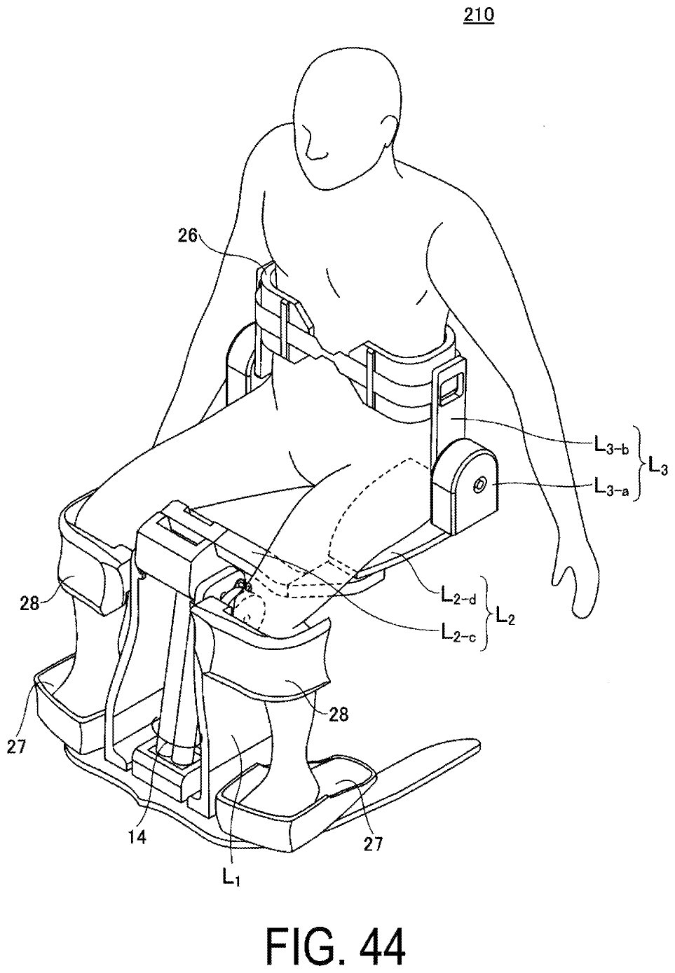

FIG. 43 illustrates a state of use of the support mechanism 210 in a standing position. FIG. 44 illustrates a state of use of the support mechanism 210 in a sitting position. In FIG. 43, the user is standing having the first link L₁ between his or her feet. The upper body of the user is fixed by the third link L₃ and the torso belt 26 connected thereto. The arms of the user are free and can raise up and lower down his or her pants by himself or herself without aid of a caregiver. As described above, the position of the torso belt 26 is higher than the waist bone or the navel. Constrains around the waist of the user are minimal and the user can easily raise up and lower down his or her pants by himself or herself.

In FIG. 44, the user is being able to be seated while straddling the support mechanism 210. Until the user has the sitting position, the support moment generated by the actuator 14 supports the thigh support L_{2-d} rotating in the horizontal direction. Constraints around the hip of the user is minimal and after the user sits on the toilet seat, the user can perform elimination while sitting.

The support mechanism 210 operates in accordance with a change in the balance between the support moment from the actuator 14 (see FIG. 41, etc.) and the load moment from the user, and does not require power supply or external control. A support operation in a standing or seating direction is induced depending on whether the sum of the support moment determined based on a posture of the rotation node 15 corresponding to the knee joint and the load moment from the user resisting the support moment is directed to the standing direction (in a case where the support moment is great) or the seating direction (in a case where the load moment from the user is great). In the design stage, a type, disposition, etc. of the actuator 14 may be calculated so that the load moment is predicted based on the height, body weight, and the like of the user and an appropriate support moment is generated based on the predicted moment.

When the support mechanism 210 is combined with a mobile body as illustrated in FIGS. 36 to 38, a driving mechanism for driving the rear wheels 3 and a controller for movement control may be provided. The mobile body needs not necessarily be of rear wheel drive, and may be of front wheel drive with the rear wheels as auxiliary wheels as long as they do not interfere with elimination.

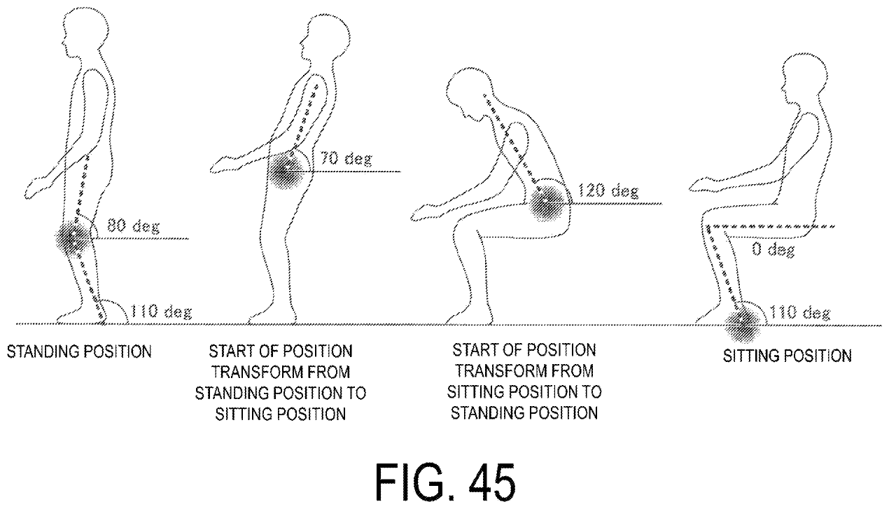

FIG. 45 is a schematic diagram of a posture transforming model applied to the support mechanism 210. In the standing position, the ankle joint of the user is at an angle of 110 degrees with respect to the reference plane on which the user is positioned, and the knee joint is at an angle of 80 degrees with respect to the reference plane. The upper body of the user is substantially perpendicular to the reference plane.

When posture transforming from the standing position to the sitting position is started, the user tilts his or her upper body backward by about 20 degrees. If ease of rotation of the end L_{3-b} of the third link L₃ can be adjusted depending on the rotation direction using, for example, a damper, or a limit is provided on an angle for rotation, the upper body of the user is stably supported by the torso belt 26 even when his or her upper body is slightly tilted backward at the start of the seating movement.

Then, when the user gradually drops his or her hip, the knee joint gradually bends, and the angle of the knee joint with respect to the reference plane changes from 80 degrees in a decreasing direction. During the transform of the posture toward the sitting position, the load on the knee joint of the user, i.e., the rotation node 15 connecting the first link L₁ and the second link L₂ increases gradually. During that time, the actuator 14 continues to generate a support moment that is slightly smaller than the load moment from the user and causes the second link L₂ to bend in a direction that is horizontal with the reference plane.

In the sitting position, the angle of the knee joint is 0 degrees, and the second link L₂ supporting the thighs is substantially horizontal with the reference plane. The ankle angle of the user is 110 degrees as in the standing position.

When posture transforming from the sitting position to the standing position is started, the user tilts his or her upper body forward by about 30 degrees. At this time, the angle of the knee joint is 0 degrees, and the angle of the ankle joint is 110 degrees. Then, the user gradually extends his or her knee joints when the hip is gradually raised to have the standing position, and the angle of the knee joints with respect to the reference plane increases. During the transform of the posture toward the standing position, the load on the knee joint of the user, i.e., the rotation node 15 connecting the first link L₁ and the second link L₂ changes dominantly in the decreasing direction. The actuator 14 continues to generate a support moment that is slightly greater than the load moment from the user and causes the second link L₂ to extend in a direction that is close to vertical

Here, the “extension” refers to a posture change in which the second link L₂ rises vertically with respect to the reference plane on which the support mechanism 210 is placed. The “bending” refers to a posture change in the direction opposite to the extension, or a posture change in the direction horizontal to the reference plane.

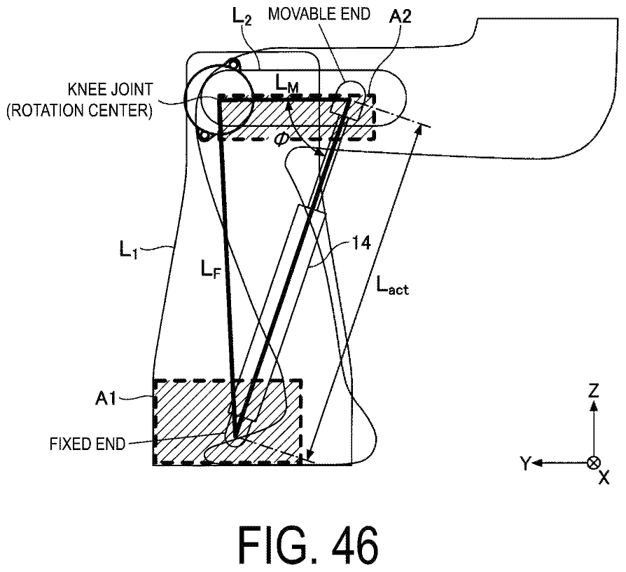

FIG. 46 is a diagram for describing the principle of a passive actuator for rotating a structure (the second link L₂) around a knee joint. The first link L₁ and the second link L₂ (more specifically, the rotating link L_{2-c}) are schematically depicted. In the actual support mechanism 210, although the thigh support L_{2-d} is coupled to the rotating link L_{2-c} as illustrated in FIG. 44 to extend to the back side of the thighs of the user, the thigh support L_{2-d} is omitted in FIG. 46.

The rotating link L_{2-c} is coupled to the first link L₁ by a rotation node 15. The fixed end of the actuator 14 is fixed to the first link L₁ or at the appropriate location on the base on which the support mechanism 210 is disposed. The other end of the actuator 14 is fixed to the rotating link L_{2-c}.

The rotating link L_{2-c} rotates around the rotation node 15 to change a posture. The posture change of the rotating link L_{2-c} changes the position of the other end of the actuator 14. In this sense, the other end of the actuator 14 may be referred to as a “movable end”.

A length from the center of rotation of the rotation node 15 to the movable end is L_{M}, a length from the center of rotation to the fixed end is L_{F}, and a length of the actuator is L_{act}. The angle formed by the reaction force of the actuator and the longitudinal axis of the rotating link L_{2-c} is φ.

The actuator 14 is provided at a position at which it does not interfere with an elimination movement of the user. The position of the fixed end of the actuator 14 is properly designed within the range of a disposition-possible region A1 of the fixed end, and the movable end of the actuator 14 is fixed within the range of a disposition-possible region A2 of the movable end. The positions of the fixed end and the movable end of the actuator 14 in the disposition-possible regions A1 and A2, the spring constant of the actuator 14, and the like are determined such that the support moment required for posture transforming of the user is generated. For example, it is designed such that, for each angle of the knee joint, a difference between a target support moment that enables a movement transition of FIG. 45 and a support moment actually generated by the actuator 14 (e.g., the sum of the squares of the errors of the target value) is minimized.

The support mechanism 210 enables posture transforming from a sitting position to a standing position or posture transforming from a standing position to a sitting position to be completed in approximately 6 to 7 seconds. In addition, because the mechanism is designed to minimize constraints on the hip and waist, the user can lower down his pants in a standing position, sit on the toilet seat in that state, stand up after finishing the elimination, and raise up the pants. Because there is no need to move the position of the user from the seat of a wheelchair to the toilet seat, the burden of the elimination can be greatly reduced.

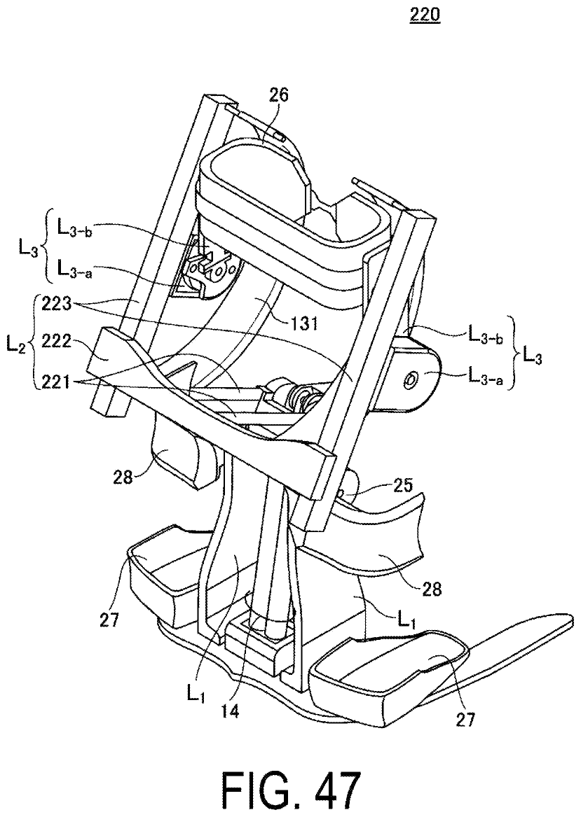

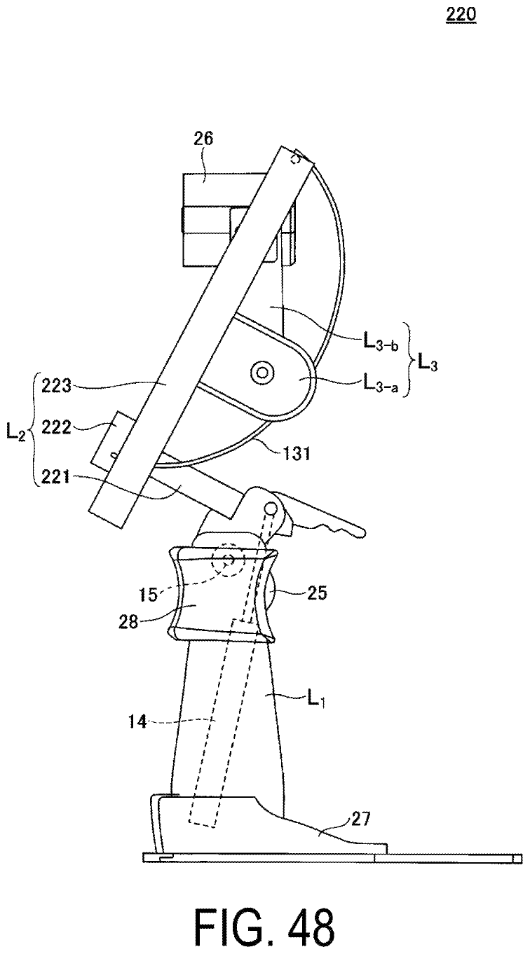

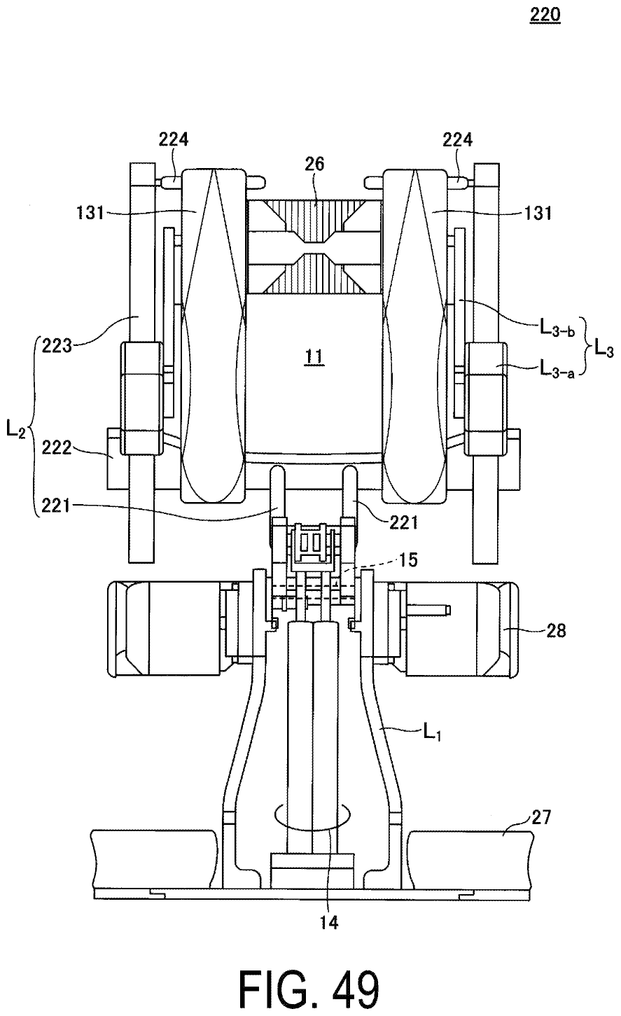

FIG. 47 is a perspective view of a support mechanism 220 of a modified example of the third embodiment, FIG. 48 is a side view of the support mechanism 220, and FIG. 49 is a rear view. Similar to the support mechanism 210 illustrated in FIGS. 39 to 44, the support mechanism 220 has a posture transforming function.

For the support mechanism 210, the thigh support L_{2-d} formed of the pair of wings 121 and 122 is used to support a user with a posture transforming movement while minimizing constraints around his hip. In the modified example, a thigh belt 131 suspended on the second link L₂ supports the back side of the thighs of the user for posture transforming.

The support mechanism 220 includes a first link L₁, a second link L₂ that is rotatably coupled to the first link L₁, thigh belts 131 that are suspended in the second link L₂, a third link L₃ that is coupled to the second link L₂, a torso belt 26 connected to the third link L₃, and an actuator 14 that rotates the second link L₂ with respect to the first link L₁.

The first link L₁ is a stationary link that has no posture change such as rotation, rocking, opening and closing, and the like. The second link L₂ is pivotable in a predetermined angular range with respect to the first link L₁ by a rotation node 15. The predetermined angular range is in the range from 0 degrees to 80 degrees, as in the first embodiment.

The second link L₂ has a rotation frame 221 and suspension frames 222 and 223 extending to opposite sides from the rotation frame 221. The rotation frame 221 and the suspension frames 222 and 223 need not be formed as separate members and may be integrally formed.

As shown in the rear view of FIG. 49, the thigh belts 131 may be suspended at pins 224 provided at the ends of the suspension frame 223. Instead of the pins 224, rod-like projections extending from the suspension frame 223 at the ends of the suspension frame 223 may be integrally formed.

The others end of the thigh belts 131 are removably hung, for example, on hooks or the like (not illustrated) on the back side of the suspension frame 222. The user straddles the first link L₁ with his or her feet in the two thigh belts 131. By allowing the thigh belts 131 to be removed, the user can turn the thigh belts 131 suspended in the pins 224 inward from the back of his or her thighs after tightening the torso belt 26 across the first link L₁ to hang the thigh belts on the hooks of the suspension frame 222. Alternatively, the torso belt 26 may be tightened across the first link L₁ after the thigh belts 131 are turned inward from the back side of the thighs and hung on the hooks. The order of mounting the thigh belts 131 and the torso belt 26 is optional.

The torso belt 26 is made removable using a buckle or the like. If the buckle of the torso belt 26 is disposed on the rear side, the user can move from the back of the support mechanism 220 to the device to do up the torso belt 26 easily.

The user can be equipped with the device including the thigh belts 131 and the torso belt 26, straddling the first link L₁ from the back of the support mechanism 220. This is the main feature of the second embodiment, which makes users to be equipped with and be detached from the device easier compared to the support mechanism 210. For example, if a user with leg paralysis uses the support mechanism 210, the user is supposed to move his or her feet from the bed or chair while the support mechanism 210 is in a sitting state, and then straddle the first link L₁ avoiding the second link L₂ and the third link L₃, however such a burden would be greatly reduced in the configuration of the modified example.

Assuming that the pins 224 or protrusions provided at the ends of the suspension frame 223 are a “first suspension part” and the hooks provided on the suspension frame 222 are a “second suspension part”, the thigh belts 131 can be removed on at least one of the first suspension part and the second suspension part. By making the thigh belts 131 removable or replaceable, a width, length, tint, material, etc. of the thigh belts 131 may be selected. If only one end side of the thigh belts 131 is made removable, a length adjustment part may be provided on the thigh belts 131.

When a user does up the thigh belts 131, the thigh belts 131 extend inward along his or her thighs from the back of them, and thus a sufficient space 11 is secured between the two thigh belts 131. The space 11 minimizes constraints around the hip and waist of the user, making it easier to raise up and lower down pants. The thigh belts 131 wrapped around the thighs support the user for movement of his or her body weight at the time of posture transforming between seating and standing positions. The user can sit on the toilet seat, using the support mechanism 220 for elimination.

The rotation frame 221 of the second link L₂ is rotatably coupled to the first link L₁ by the rotation node 15. The rotation frame 221 is connected to one end side of the actuator 14 to receive a support moment for posture transforming from the actuator 14. The functions and operations of the actuator 14 are the same as those in the first embodiment, and thus overlapping descriptions thereof are omitted.

When a user transitions from a standing position to a sitting position, the suspension frame 223 moves in a direction horizontal to the reference plane on which the support mechanism 220 is placed. At this time, the thigh belts 131 are wrapped around the thighs of the user on the back side to reliably support the seating position of the user. The thigh belts 131 are formed of a fabric, semi-synthetic fiber, synthetic fiber, or the like. The materials are flexible and give a good sense of fitting to the thighs, compared to a plastic-molded thigh support.

The torso belt 26 is connected to the third link L₃ to stably support the user during the posture transforming without constraints around the hip, as in the first embodiment. The torso belt 26 fixes the torso at a position higher than the waist bone of the user, or a position higher than the navel.

The third link L₃ and the torso belt 26 allow the user to stably transform posture without losing his or her posture. By providing the torso belt 26 at a higher position than the waist bone, it is easy for the user to raise up or lower down his or her pants or underwear at the time of elimination. The user can smoothly perform a series of actions of lowering down pants to sit on the toilet seat and then raising up the pants after that while his or her upper body is firmly supported by the torso belt 26.

In the third embodiment, the frame structure including the first link L₁, the second link L₂, and the third link L₃ does not conflict with the movement of the user to raise up and lower down his or her pants and ensures a sufficient space around his or her hip. The thigh support L_{2-d} or the thigh belts 131 can support posture transitions between the sitting and standing positions with minimal constraints around the hip and waist of the user.

The support mechanism according to the third embodiment is not limited to the specific configuration example described above. The thigh support or the thigh belts may take any form that can support posture transforming between the sitting and standing positions with the hip and waist of the user released. For example, a layer of an elastic body such as silicone, elastomer, or the like may be provided on the support surface of the thigh support or the thigh belts that comes into contact with the thighs of the user.

The actuator 14 may be configured to be locked. In this case, when the actuator is unlocked, the rotation node 15 corresponding to the knee joint can be operable. A standing movement can be started when the user tilts his or her upper body forward, and a seating movement can be started when the user tilts his or her upper body backward. A movement for a posture transition can be optionally stopped or reversed when the user adjusts the posture of his or her upper body. After transitioning to a desired posture and stopping the movement of the knee joints, the user may lock the actuator 14 to place his or her knee joints in a fixed state. This locking operation can allow users to safely use the support mechanism 210 or 220.

The present application claims its priority based on Japanese Patent Application No. 2019-159109 filed Aug. 30, 2019, Japanese Patent Application No. 2019-159110 filed on Aug. 30, 2019, and Japanese Patent Application No. 2019-178827, filed on Sep. 30, 2019, the entire contents of the three Japanese patent applications are included in the present application.

### REFERENCE SIGNS LIST

1, 101, 101A, 201 Mobile apparatus
2 Front wheel
3 Rear wheel
4, 27 Footrest
10, 10A, 110, 110A, 210, 220 Support mechanism
13 Base
14 Actuator
141 Elastic body
15 Rotation node
16 Support band
17 Rotation node
26 Torso belt
28 Knee joint support member
31, 31₁ to 31ₙ Pressure sensor
40 Support moment adjustment mechanism
131 Thigh belt
221 Rotation frame
222, 223 Suspension frame
224 Pin
A1 Disposition-possible region for fixed end of actuator 14
A2 Disposition-possible region for movable end of actuator 14
CM1 Centroid of thighs of user
CM2 Centroid of upper body of user
L₁ First link
L₂ Second link
L₂₋ₐ Link body
L_{2-b} Support link
L_{2-c} Rotating link
L_{2-d} Thigh support
L₃ Third link
L₃₋ₐ Base
L_{3-b} End
P₁ Knee joint position
P₂ Hip joint position
PL1 Reference plane parallel to RP passing through knee joint rotation center
PL2 Reference plane parallel to RP passing through hip joint rotation center
RP Reference plane
RP1 Relative positional relationship between knee joint and centroid of upper body
RP2 Relative positional relationship between ankle joint and knee joint
θₐ Ankle joint angle (angle formed by line segment connecting ankle joint and knee joint of user and reference plane RP)
θₖ Knee joint angle (angle formed by line segment connecting knee joint and hip joint of user and reference plane RP)
θₕ Hip joint angle (angle formed by line segment connecting hip joint and acromion of user and reference plane RP)
τ Combined moment of support moment and load moment on knee joint
τₐ Support moment
τ_{AG} Knee joint support moment generated by support mechanism
τ_{AZ} Knee joint support moment generated by mechanism of reference example
τ_{HBM} Load moment from user
τ_{2M} Support moment on knee joint of user
τ_{3M} Support moment on waist joint of user

1. A support mechanism that is a mechanism to support a posture transition, the mechanism comprising:
a first link that does not change a posture;
a second link that is rotatably coupled to the first link; and
an actuator configured to rotate the second link with respect to the first link,
wherein, when a load on a connection part of the second link and the first link changes due to a change in an upper body posture of a user, based on a relative positional relationship between an ankle joint and a knee joint of the user in a direction orthogonal to a vertical direction in a sagittal plane of the user, the actuator drives the second link while changing a support moment on the user according to a relative positional relationship between the knee joint and an upper body centroid, or a knee joint angle.

2. The support mechanism according to claim 1, wherein the actuator is a passive component that does not require supply of power.

3. The support mechanism according to claim 1,
wherein the actuator rotates the second link in a direction in which the second link extends at a time of a transition from a sitting position to a standing position and rotates the second link in a direction in which the second link bends at a time of a transition from the standing position to the sitting position,
wherein the support moment generated by the actuator decreases and is greater than a load moment on the connection part at a time of a transition from the sitting position to the standing position, and
wherein the support moment increases and is smaller than the load at a time of a transition from the standing position to the sitting position.

4. The support mechanism according to claim 1, further comprising:
a support moment adjustment mechanism configured to adjust a support moment generated according to physical characteristics of a user.

5. The support mechanism according to claim 1, further comprising:
a third link that is rotatably coupled to the second link; and
a force transmission mechanism configured to transmit a force between the second link and the third link,
wherein the actuator and the force transmission mechanism drive the second link and the third link while changing the support moment when a load on the connection part of the second link and the first link changes.

6. The support mechanism according to claim 5,
wherein the force transmission mechanism rotates the third link in a direction in which the third link extends at a time of a transition from a sitting position to a standing position and rotates the third link in a direction in which the third link bends at a time of a transition from the standing position to the sitting position.

7. The support mechanism according to claim 5,
wherein the force transmission mechanism includes a combination of a plurality of pulleys with wires suspended between the pulleys, or a combination of a plurality of transmission rods.

8. The support mechanism according to claim 1, further comprising:
a third link coupled to the second link; and
a torso belt connected to the third link,
wherein the second link includes a rotating link coupled to the first link and a thigh support coupled to the rotating link to support thighs of the user from a back side at a time of posture transforming, and
wherein the thigh support and the torso belt support posture transforming with a hip and a waist of the user released.

9. The support mechanism according to claim 1, further comprising:
a third link coupled to the second link;
a thigh belt attached to the second link and configured to be detachable; and
a torso belt connected to the third link,
wherein the thigh belt supports thighs of the user with a hip of the user released when the thigh belt is attached to the second link, and
wherein the torso belt is configured to hold an upper body of the user at a position higher than a waist bone of the user.

10. A mobile apparatus comprising:
the support mechanism according to claim 1; and
a wheel configured to cause the support mechanism to move.

11. The mobile apparatus according to claim 10, further comprising:
a sensor configured to sense a distribution of pressure, the pressure being applied from the user to the support mechanism,
wherein the wheel is driven in a direction according to the distribution of pressure.
